(19) United States
(12) Patent Application Publication
(10) Pub. No.: US 2025/0379730 A1
(43) Pub. Date: Dec. 11, 2025

(54) KEY REFRESH UTILIZING TAMPER-RESISTANT PUBLIC KEY COMMITMENT

(71) Applicant: Microsoft Technology Licensing, LLC, Redmond, WA (US)

(72) Inventors: Ramarathnam VENKATESAN, Redmond, WA (US); Mariusz H. JAKUBOWSKI, Bellevue, WA (US); Kartik GUPTA, Seattle, WA (US); Subhra BOSE, Ossining, NY (US); Paul Alan STIRPE, Shoreham, NY (US)

(21) Appl. No.: 18/737,138

(22) Filed: Jun. 7, 2024

(51) Int. Cl. H04L 9/08; H04L 9/32

(52) U.S. Cl. CPC H04L 9/0894; H04L 9/0869; H04L 9/3221

(57) ABSTRACT

Systems, methods, and computer readable storage media described herein provide key refreshment utilizing tamper-resistant public key commitment. In an aspect, a ledger manager stores a set of public keys associated with a user account in a ledger database. The ledger manager assigns a first public key of the set of public keys as an active key. Responsive to receiving an update key request from a computing device on behalf of the user account, the ledger manager updates the active key to a second public key of the set of public keys. Responsive to receiving an active key request from another computing device on behalf of a another user account, the ledger manager causes data accessible to the another computing device to be encrypted using the second public key. In an aspect, the ledger manager utilizes the second public key to encrypt second data accessible to the another computing device.

### BACKGROUND

Public-key cryptography (also known as asymmetric cryptography) is a cryptographic system that uses pairs of keys. Each pair consists of a public key (which is known to others) and a private key (which is (e.g., only) known to the owner). In some implementations of public-key cryptography, key pairs are refreshed such that prior private keys and public keys are invalid for cryptographic operations. Effective security requires keeping key refresh secure.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Embodiments described herein utilize tamper-resistant public key commitment for use in key refreshment. For example, in an aspect, a system comprises a ledger database and a ledger manager. The ledger manager stores a set of public keys associated with a first user account in the ledger database. The ledger manager (or the ledger database) assigns a first public key of the set of public keys as an active key. Responsive to receiving an update key request from a first computing device on behalf of the first user account, the ledger manager updates the active key to a second public key of the set of public keys. Responsive to receiving an active key request from a second computing device on behalf of a second user account, the ledger manager causes data accessible to the second computing device to be encrypted using the second public key.

In a further aspect, the ledger manager utilizes the second public key to encrypt second data accessible to the first application.

In a further aspect, the ledger manager provides the second public key to the second application.

In an alternative aspect, a system comprises a manager service that maintains an active count corresponding to an active private key of a first user account. The manager service receives an active key request. Responsive to the active key request, the manager service generates a public key corresponding to the active private key based on the active count and a seed value. The manager service causes data to be encrypted with the generated public key.

### BRIEF DESCRIPTION OF THE DRAWINGS/FIGURES

The accompanying drawings, which are incorporated herein and form a part of the specification, illustrate embodiments and, together with the description, further serve to explain the principles of the embodiments and to enable a person skilled in the pertinent art to make and use the embodiments.

FIG. 1 shows a block diagram of an example system for key refresh utilizing a tamper resistant public key commitment technique, in accordance with an example embodiment.

FIG. 2 shows a block diagram of a system for key refreshment, in accordance with an example embodiment.

FIG. 3A shows a flowchart of a process for committing public keys, in accordance with an embodiment.

FIG. 3B shows a flowchart of a process for refreshing a key and utilizing the refreshed key, in accordance with an example embodiment.

FIG. 4 shows a flowchart of a process for causing data to be encrypted, in accordance with an example embodiment.

FIG. 5 shows a block diagram of a system for causing data to be encrypted, in accordance with another example embodiment.

FIG. 6 shows a flowchart of a process for causing data to be encrypted, in accordance with another example embodiment.

FIG. 7 shows a flowchart of a process for updating an active key, in accordance with an example embodiment.

FIG. 8 shows a block diagram of a ledger database, in accordance with an example embodiment.

FIG. 9 shows a block diagram of a system for updating a set of keys, in accordance with an example embodiment.

FIG. 10 shows a flowchart of a process for updating a set of keys, in accordance with an example embodiment.

FIG. 11 shows a block diagram of a system for validating a key, in accordance with an example embodiment.

FIG. 12 shows a flowchart of a process for validating a key, in accordance with an example embodiment.

FIG. 13 shows a block diagram of a system for updating an active key and a verifiable identity map, in accordance with an example embodiment.

FIG. 14 shows a flowchart of a process for updating an active key and a verifiable identity map, in accordance with an example embodiment.

FIG. 15 shows a block diagram of a system for supporting key refresh with respect to multiple users, in accordance with an example embodiment.

FIG. 16 shows a flowchart of a process for providing access to a refreshed key to multiple requesting users, in accordance with an example embodiment.

FIG. 17 shows a block diagram of an example computer system in which embodiments may be implemented.

The subject matter of the present application will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION

### I. Introduction

The following detailed description discloses numerous example embodiments. The scope of the present patent application is not limited to the disclosed embodiments, but also encompasses combinations of the disclosed embodiments, as well as modifications to the disclosed embodiments. It is noted that any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

### II. Example Embodiments of Public Key Refresh

Public-key cryptography (also known as asymmetric cryptography) is a cryptographic system that uses pairs of keys. Each pair consists of a public key (which is known to others) and a private key (which is (e.g., only) known to the owner). In some implementations of public-key cryptography, key pairs are refreshed such that prior private keys and public keys are invalid for cryptographic operations. Effective security requires keeping the private key private, whereas the public key can be openly distributed.

One potential security vulnerability in using asymmetric keys is the possibility of a “man-in-the-middle” attack, in which the attacker secretly relays and possibly alters the communications between two parties who believe that they are directly communicating with each other, as the attacker has inserted themselves between the two parties. For instance, suppose Alice asks Bob for his public key. If Bob sends his public key to Alice, but Charles is able to intercept it, a “man-in-the-middle” attack can begin, where Charles sends Alice a forged message that appears to originate from Bob, but instead includes Charles' public key. Alice, believing this public key to be Bob's, encrypts her message with Charles' public key and sends the encrypted message back to Bob. Charles intercepts the message, decrypts the message using his private key, and may utilize the message for nefarious purposes. Subsequently, Charles encrypts the message with Bob's public key (e.g., after optionally modifying the message (e.g., to obfuscate Charles' interception)) and sends the newly encrypted message to Bob, thereby maintaining an illusion that Bob is communicating (e.g., directly) with Alice.

Furthermore, as noted above, a user's key pair may be refreshed (e.g., periodically or in response to a refresh request). In some forms of “man-in-the-middle” attacks, an attacker poses as a legitimate party refreshing their public key. For instance, in an alternative scenario to the one described above, Charles poses as Bob updating his public key and provides a forged message to Alice comprising Charles's public key. Alice, believing this public key to be Bob's, utilizes the key to perform encryption operations and sends messages back to Bob (which are then intercepted and decrypted by Charles).

Embodiments described herein provide a public key infrastructure that is tamper-resistant. For instance, a system comprises a ledger database comprising multiple public keys associated with a first user (e.g., Bob). One of the keys of the multiple public keys is an active public key, e.g., “Key A”. In this context, the active public key corresponds to an active private key that Bob (or applications/devices on behalf of Bob) are utilizing to decrypt data/messages. A second user (e.g., Alice), or a computing device or application on behalf of the user, obtains the active key from the ledger database and utilizes the active key to encrypt data and/or a message to be transmitted to a computing device of the first user. In an example, Bob (or a computing device or an application on behalf of Bob) causes a key refresh operation to be performed. For instance, a ledger manager updates the active key of the ledger database from Key A to a second public key of the set of public keys, e.g., “Key B.” In this context, Alice (or other users and/or applications) obtains Key B from the ledger database and utilizes the active key (which is now Key B) to encrypt data and/or messages to be transmitted to Bob. By utilizing a tamper-resistant ledger database comprising multiple committed public keys in this manner, embodiments described herein prevent injection of never-before-seen keypairs into a set of acceptable options, thereby preventing man-in-the-middle attacks that substitute attacker keypairs for expected ones.

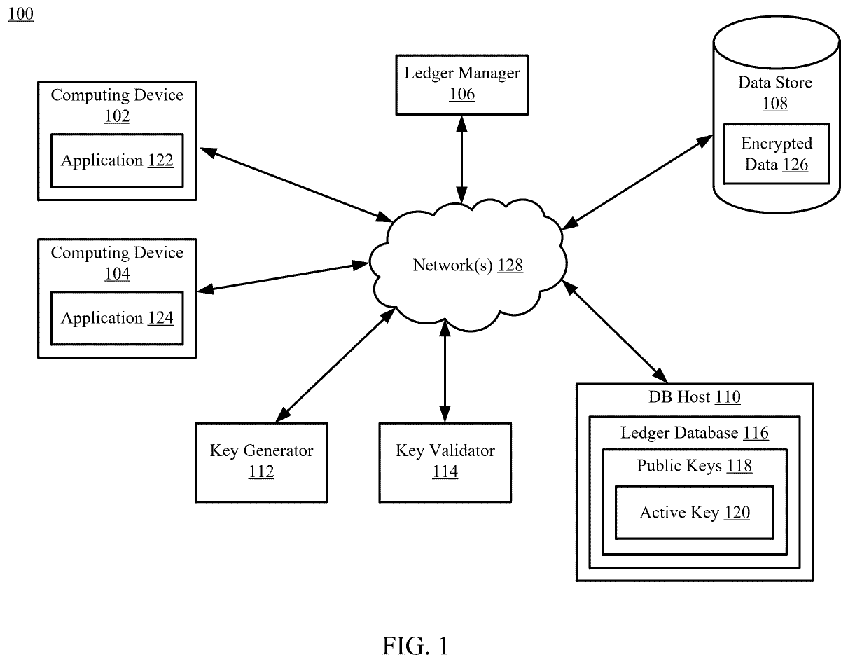

Embodiments of systems implementing tamper-resistant public key commitment for key refresh are configured in various ways. For instance, FIG. 1 shows a block diagram of an example system 100 for key refresh utilizing a tamper resistant public key commitment technique, in accordance with an example embodiment. System 100 comprises a computing device 102, a computing device 104, a ledger manager 106, a data store 108, a database host 110 (“DB host 110” herein), a key generator 112, and a key validator 114, which are communicatively coupled via a network 128. In examples, network 128 comprises one or more networks such as local area networks (LANs), wide area networks (WANs), enterprise networks, the Internet, etc. In examples, network 128 comprises one or more wired and/or wireless portions. The features of system 100 are described in detail as follows.

Data store 108 is configured to store data utilized by and/or generated by computing device 102, computing device 104, ledger manager 106, DB host 110, key generator 112, and/or key validator 114. For instance, data store 108 of FIG. 1 stores encrypted data 126. In accordance with an embodiment, encrypted data 126 is encrypted by ledger manager 106. Alternatively, encrypted data 126 is encrypted by an application utilizing a key provided by ledger manager 106. In accordance with an embodiment, encrypted data 126 is accessible to a computing device (e.g., computing device 104) that an associated user intends to share with another user associated with another computing device (e.g., computing device). In this context, computing device 104 causes encrypted data 126 to be encrypted in a manner that is accessible to computing device 102, as described elsewhere herein.

As shown in FIG. 1, data store 108 is external to computing device 102, computing device 104, ledger manager 106, DB host 110, key generator 112, and key validator 114. Alternatively, some or all of data store 108 is internal to computing device 102, computing device 104, ledger manager 106, DB host 110, key generator 112, and/or key validator 114. In accordance with an embodiment, data store 108 is a remote storage accessible over network 128.

Computing devices 102 and 104 are each any type of stationary or mobile processing device, including, but not limited to, a desktop computer, a server, a mobile or handheld device (e.g., a tablet, a personal data assistant (PDA), a smart phone, a laptop, etc.), an Internet-of-Things (IoT) device, etc. In accordance with an embodiment, computing device 102 is associated with a first user (e.g., an individual user, a group of users, an organization, a family user, a customer user, an employee user, a tenant, etc.) and computing device 104 is associated with a second user. As shown in FIG. 1, computing device 102 executes an application 122 and computing device 104 executes an application 124. Applications 122 and 124 enable respective computing devices 102 and 104 to interact with ledger manager 106, data store 108, DB host 110, key generator 112, and/or key validator 114 over network 128. In accordance with an embodiment, computing device 102 and/or application 122 are associated with a user that has public keys managed by DB host 110, as described elsewhere herein, and computing device 104 and/or application 124 are associated with a user that intend to utilize a public key managed by DB host 110 (e.g., in order to send encrypted data and/or messages to the user associated with computing device 102 and/or application 122).

Ledger manager 106, DB host 110, key generator 112, and/or key validator 114 comprise one or more server computers (e.g., cloud-based servers, distributed servers, and/or the like) or other computing devices. In accordance with an embodiment, ledger manager 106, data store 108, DB host 110, key generator 112, and/or key validator 114 are integrated in a cloud-based or enterprise environment provided by a service provider. Alternatively (or additionally), one or more of ledger manager 106, data store 108, DB host 110, key generator 112, and/or key validator 114 are implemented in a third-party system separate from the service provider's environment.

DB host 110 executes one or more ledger databases. For instance, as shown in FIG. 1, DB host 110 executes ledger database 116. Ledger database 116 provides tamper-evident capabilities for database tables of ledger database 116 (referred to as “ledger tables”), where the data of a ledger table can be cryptographically attested to other parties, such as auditors or parties that interact with ledger database 116, that the data maintained by ledger database 116 has not been tampered with. Ledger database 116 protects data from attackers or high privileged users, including database administrators, system administrators, and cloud administrators. In accordance with an embodiment, historical data is preserved by ledger database 116. For instance, in an example embodiment, if a row is updated in a ledger table, its previous value is maintained and protected in a history table. In this context, ledger database 116 provides a chronicle of (e.g., all) changes made to ledger database 116 over time. In some implementations, historical data is maintained in a relational form to support queries (e.g., SQL queries) for auditing, forensics, and/or other purposes.

In some implementations, rows of ledger database 116 that are modified by a transaction in the ledger table are cryptographically hashed (e.g., SHA-256 hashed) using a data structure, such as a Merkle tree, that creates a root hash representing all rows in the transaction. The transactions that the ledger database processes are then also hashed together through another Merkle tree data structure. The result is a root hash that forms a block. The block is then hashed through the root hash of the block, along with the root hash of the previous block as input to the hash function. That hashing forms a blockchain. The root hash, also referred herein as a database digest, contains the cryptographically hashed transactions and represents the state of ledger database 116 at the time the digest was generated. In accordance with an embodiment, a digest is periodically generated and stored outside ledger database 116 in tamper-proof storage (not shown in FIG. 1 for brevity). A digest is later used to verify the integrity of ledger database 116 by comparing the value of the hash in the digest against a calculated hash in ledger database 116.

In accordance with an embodiment, materialized views of ledger table 116 are generated in fixed periodic intervals referred to as epochs. In accordance with an embodiment, ledger database 116 is also configured to provide forward integrity, which guarantees that given a materialized view of ledger table 116 at any time t, it is infeasible to tamper ledger table 116 in any subsequent epoch.

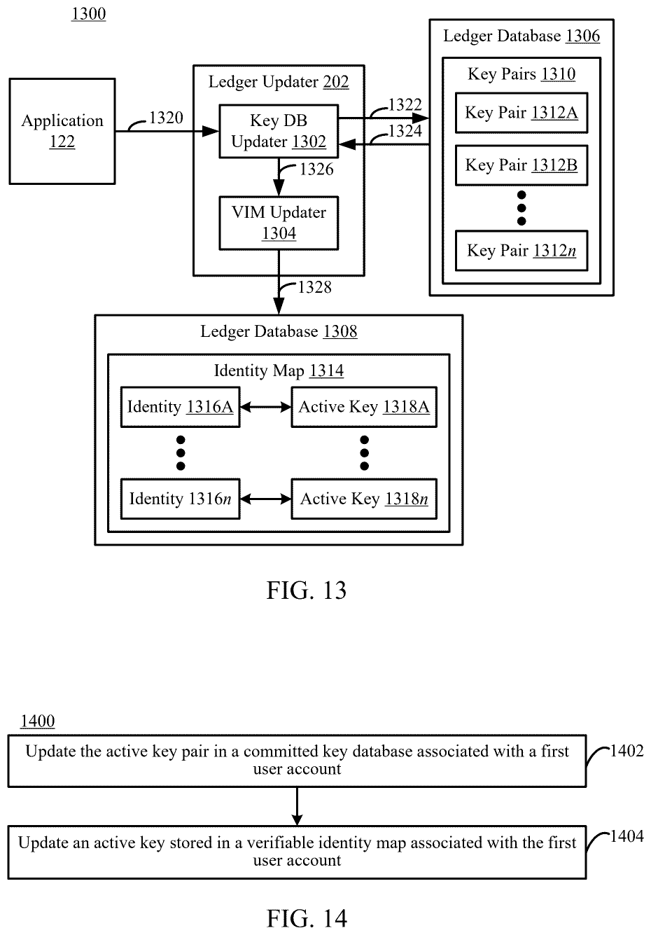

Ledger database 116 is configured to store and protect any type of data or information, including, but not limited to public keys (e.g., public keys 118, as shown in FIG. 1), private keys, key pairs (e.g., as further described with respect to FIG. 8, as well as elsewhere herein), a verifiable identity map (e.g., as further described with respect to FIGS. 13 and 14, as well as elsewhere herein), a verifiable attribute map, and/or a verifiable policy map. Ledger database 116 is configured to provide users (e.g., users of computing devices 102 and 104 and/or other users of other computing devices not shown in FIG. 1) access to a digest, which is representative of the state of ledger database 116. Computing devices and/or systems, in some implementations, store the digest. It is noted that in embodiments, ledger database 116 is configured to provide access to the digest over time.

Key generator 112 is configured to generate key pairs on behalf of an entity (e.g., a user, a computing device, a system, an organization, and/or the like). For example, key generator 112 in accordance with an embodiment generates one or more key pairs, wherein each key pair comprises a private key and a corresponding public key. A public key is usable by entities to encrypt data such that (e.g., only) the corresponding private key is able to decrypt the data. In embodiments, the private keys are kept private (e.g., to the entity they correspond to, to key generator 112, to a trusted key handler, etc.) and others are allowed access to the public keys (e.g., either directly such that the entity is able to encrypt data to be accessed by the entity possessing the private key or indirectly such that the entity is able to utilize a third party service to encrypt the data). In accordance with an embodiment, part of or all of the generated key pairs are stored in a ledger (e.g., ledger database 116). For instance, as shown in FIG. 1, ledger database 116 stores public keys 118 of key pairs generated by ledger manager 106.

Ledger manager 106 is configured to manage ledgers hosted by DB host 110, as well as access to and/or operations performed with respect to ledgers hosted by DB host 110. For example, ledger manager 106 is configured to append to ledger database 116, to retrieve a public key of public keys 118, to designate an active key of public keys 118, to rotate public keys of public keys 118, and/or to perform any other operation with respect to ledger database 116 (or another ledger database hosted by DB host 110) described elsewhere herein. For instance, ledger manager 106, in embodiments, receives public keys from key generator 116 and causes ledger database 116 to store them as public keys 118, designates a public key of public keys 118 as an active key 120, rotates active key 120 from one public key to another, obtains a current active key 120 and provides it to an application (e.g., application 122, application 124, and/or the like), and/or the like. In some embodiments, multiple instances of ledger manager 106 (e.g., in a federation or group of instances) manage ledgers hosted by DB host 110 such that each instance of ledger manager 106 is able to access the most recently updated version of the ledger (e.g., ledger database 116). Furthermore, in some instances, there are multiple instances of ledger database 116. In this context, ledger manager 106 (or an instance of ledger manager 106) manages the multiple instances of ledger database 116 in a manner that causes each instance of the ledger to be updated.

Key validator 114 is configured to determine whether or not a key is a valid key. For example, key generator 112 determines if a public key is a valid public key stored by ledger database 116. In accordance with an embodiment, key validator 114 determines the public key is a valid key without access ledger database 116. In accordance with other additional and/or alternative embodiments, key validator 114 determines if the public key is active key 120, determines if the public key is valid based on data utilized to generate public keys 118, notifies an entity if a key is valid, and/or performs any other operation described herein associated to validation of keys. In embodiments, key validator 114 is able to validate a key without exposing the corresponding private key (which is kept secret). In accordance with an embodiment, key validator 114 validates the key utilizing a zero-knowledge (e.g., cryptographic) proof.

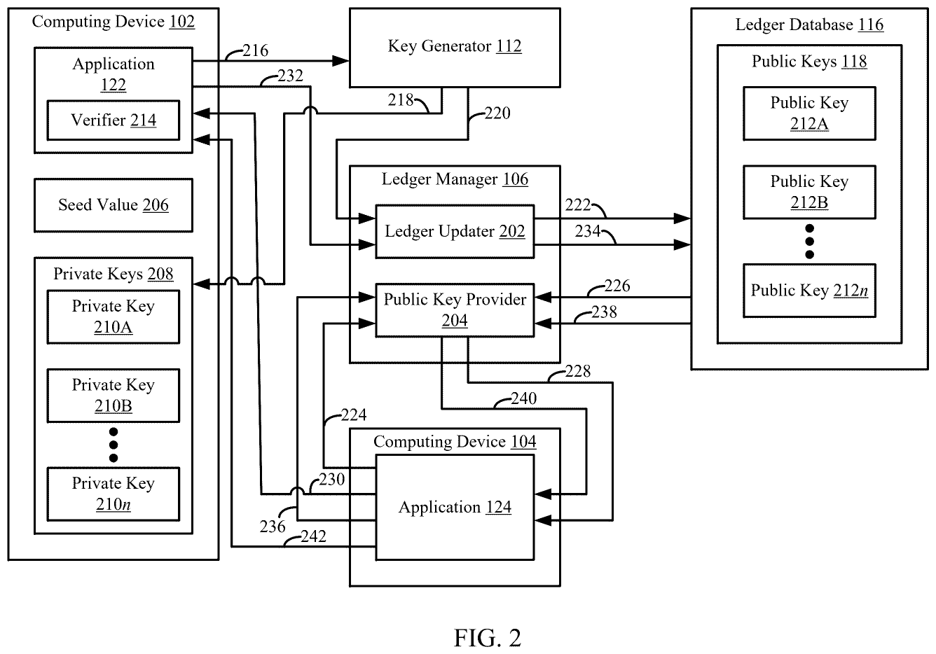

Embodiments of ledger manager 106 operate in a manner that enables key generation, storage of keys in a tamper-evident ledger database, and rotation of keys (also referred to as “key refreshment”). Systems comprising a ledger manager such as manager 106 are configured in various ways, in embodiments. For example, FIG. 2 shows a block diagram of a system 200 for key refreshment, in accordance with an example embodiment. As shown in FIG. 2, system 200 comprises computing device 102, computing device 104 (executing application 124), ledger manager 106, key generator 112, and ledger database 116 (comprising public keys 118), as described with respect to FIG. 1. As also shown in FIG. 2, computing device 102 comprises application 122 (as described with respect to FIG. 1), as well as a seed value 206 and private keys 208. Seed value 206 is a value utilized to generate keys on behalf of computing device 102. In accordance with an embodiment, and as shown in FIG. 2, seed value 206 is stored by computing device 102. Alternatively, seed value 206 is stored external to computing device 102. Depending on the implementation, seed value 206 is generated by computing device 102 (e.g., as a result of user input with application 122), generated by key generator 112 (e.g., in the generation of the keys that seed value 206 was generated for), generated randomly or pseudo-randomly, and/or predetermined by a developer user.

Private keys 208 comprise one or more private keys of the user associated with computing device 102 (e.g., Bob in the running examples described with respect to FIG. 1). For instance, as shown in FIG. 2, private keys 208 comprise private key 210A, private key 210B, and private key 210n; however, embodiments described herein may include any number of private keys, including, but not limited to, one private key, two private keys, less than ten private keys, tens of private keys, hundreds of private keys, and even greater numbers of private keys. In accordance with an embodiment, private keys 208 are stored in an encrypted format (e.g., such that a master decryption key must be used to access a decrypted form of the encrypted key). As shown in FIG. 2, private keys 208 are stored by computing device 102 (e.g., in system memory of computing device 102). Alternatively, or additionally, some or all of private keys 208 are stored in memory external to computing device 102 (e.g., an external hard drive coupled to computing device 102, cloud storage accessible to computing device 102 over a network (e.g., network 128), memory of a key management service (e.g., a trusted key manager that stores or otherwise has access to unencrypted versions of private keys 208 or an untrusted key manager that stores or otherwise has access to encrypted versions of private keys 208) and/or in another memory external to computing device 102. In accordance with an embodiment, one of private keys 210A-210n is designated as an active private key.

While private keys 208 are shown in FIG. 2 as comprising private keys, in some embodiments, computing device 102 (or an external memory) store private keys and their corresponding public keys. Furthermore, as shown in FIG. 2, public keys corresponding to private keys 210A-210n are stored in ledger database 116 as public keys 118. As shown in FIG. 2, public keys 118 comprise public keys 212A-212n, where public key 212A corresponds to private key 210A, public key 212B corresponds to private key 210B, public key 212n corresponds to private key 210n. For instance, public key 212A can be used to encrypt data or messages such that only private key 210A is able to decrypt the encrypted data or message, public key 212B can be used to encrypt data or messages such that only private key 210B can be used to decrypt the encrypted data or message, and so on. In embodiments, key generator 112 generates private keys 208 and public keys 118, as described elsewhere herein.

Application 122 operates in a similar manner as described with respect to FIG. 1. As further shown in FIG. 2, application 122 comprises a verifier 214. Verifier 214 is implemented as a sub-service of application 122, in embodiments. In accordance with an embodiment, verifier 214 is configured to decrypt encrypted messages and/or data utilizing the active private key of private keys 208.

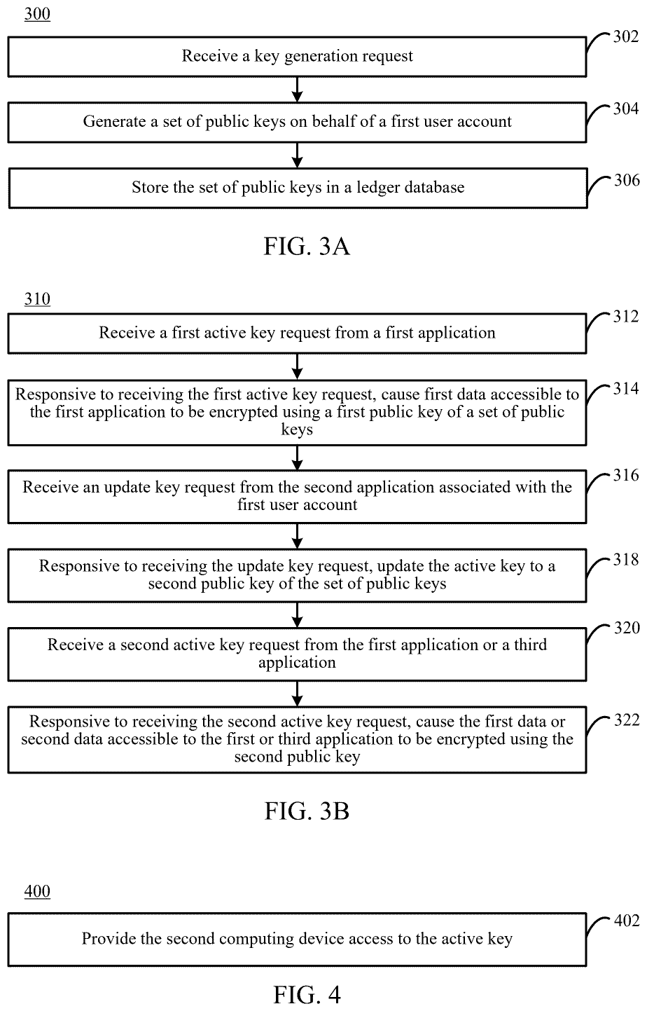

Ledger manager 106 operates in a similar manner as described with respect to FIG. 1. As shown in FIG. 2, ledger manager 106 comprises a ledger manager updater 202 and a public key provider 204, each of which are implemented as sub-services and/or sub-components of ledger manager 106. Ledger updater 202 is configured to update and/or otherwise manage ledger database 116. Public key provider 204 is configured to provide public keys to requesting applications. To better understand the operation of key generator 112 and ledger manager 106 comprising ledger updater 202 and public key provider 204, FIG. 2 is described with respect to FIGS. 3A and 3B. For example, FIG. 3A shows a flowchart 300 of a process for committing public keys, in accordance with an embodiment. In an embodiment, system 200 operates according to flowchart 300. Note not all steps of flowchart 300 need be performed in all embodiments. Further structural and operational embodiments will be apparent to persons skilled in the relevant art(s) based on the following descriptions of FIGS. 2 and 3A.

Flowchart 300 begins with step 302. In step 302, a key generator request is received. For example, key generator 112 of FIG. 2 receives a key generator request 216. Key generator request 216 in accordance with an embodiment comprises instructions to generate key pairs on behalf of a user associated with application 122 (e.g., Bob). In accordance with an embodiment, key generator request 216 comprises a user identifier that uniquely identifies the user and/or a seed value (e.g., seed value 206). Alternatively, or additionally, key generator 112 generates or otherwise determines a seed value to be utilized to generate keys responsive to key generator request 216.

In step 304, a set of public keys is generated on behalf of a first user account. For example, key generator 112 of FIG. 2 generates a set of public keys 218 (“public keys 218” herein) on behalf of a first user account (e.g., the user account associated with application 122 and/or computing device 102 (e.g., Bob's user account)). In accordance with an embodiment, key generator 112 generates private keys 218 and public keys 220 based on seed value 206 and/or a user ID of Bob. As shown in FIG. 2, key generator 112 provides private keys 218 to computing device 102 (e.g., for storage thereby as private keys 208) and provides public keys 220 to ledger updater 202. In some embodiments, key generator provides the entire key pairs to computing device 102 and/or ledger updater 202.

In step 306, the set of public keys is stored in a ledger database. For example, as shown in FIG. 2, ledger updater 202 receives public keys 218 and stores public keys 220 in ledger database 116 as public keys 118 via storage signal 222. In accordance with an embodiment, ledger updater 202 determines public keys 220 were generated by key generator 112. For instance, in accordance with an embodiment, key generator 112 signs public keys 220 with a signing key of key generator 112 (which is kept secret to key generator 112) and ledger updater 202 verifies the signature utilizing a verification key (which is provided to ledger updater 202 via communication with key generator 112 not shown in FIG. 2). By verifying the origin of public keys 220, ledger updater 202 ensures public keys 220 are authentically generated by key generator 112. In accordance with an embodiment, public keys 220 include an indication of which user account (e.g., Bob's user account) the keys are associated with. In this context, ledger updater 202 determines which ledger to update based on the indicated account. In accordance with an embodiment, public keys 220 already includes an indication of which public key is the active key. Alternatively, ledger updater 202 determines which public key is the active key. In another alternative embodiment, application 122 provides an update request (not shown in FIG. 2) to ledger updater 202 to indicate which key should be the active key. In accordance with an embodiment, ledger updater 202 indicates in ledger database 116 which public key of stored public keys 118 is the active key. As described with respect to FIG. 1, some instances of ledger database 116 include multiple instances in a federation or group of instances. In such embodiments, ledger updater 202 updates each instance of ledger database 116 to include stored public keys 118 and an indication of the active key.

By using a tamper-evident ledger database, e.g., ledger database 116, embodiments of the present disclosure enable users, applications, and/or computing devices described herein can cryptographically attest to other parties, such as auditors or parties that the data maintained by ledger database 116 has not been tampered with. In other words, ledger database 116 prevents a malicious entity from injecting new, never-before-seen keypairs as a set of acceptable options without the change being detectable by an auditor or party that maintains ledger database 116, thereby improving security in key refreshment implementations.

As stated above, to better understand the operation of ledger updater 202 and public key provider 204, FIG. 2 is described with respect to FIG. 3B. FIG. 3B shows a flowchart 310 of a process for refreshing a key and utilizing the refreshed key, in accordance with an example embodiment. Ledger manager 106 of FIG. 2 operates according to flowchart 310 in accordance with an embodiment. Not all steps of flowchart 310 need be performed in all embodiments. Further structural and operational embodiments will be apparent to persons skilled in the relevant art(s) based on the following descriptions of FIGS. 2 and 3B.

Flowchart 310 begins with step 312. In step 312, a first active key request is received from an application. For example, public key provider 204 receives an active key request 224 from application 124. In accordance with an embodiment, active key request 224 is a request for a currently active key of the first user account (e.g., Bob's active key). In accordance with an embodiment, application 124 is associated with a user account different from the first (e.g., Alice's user account). In some embodiments, active key request 224 comprises a user identifier that uniquely identifies the user account associated with application 124.

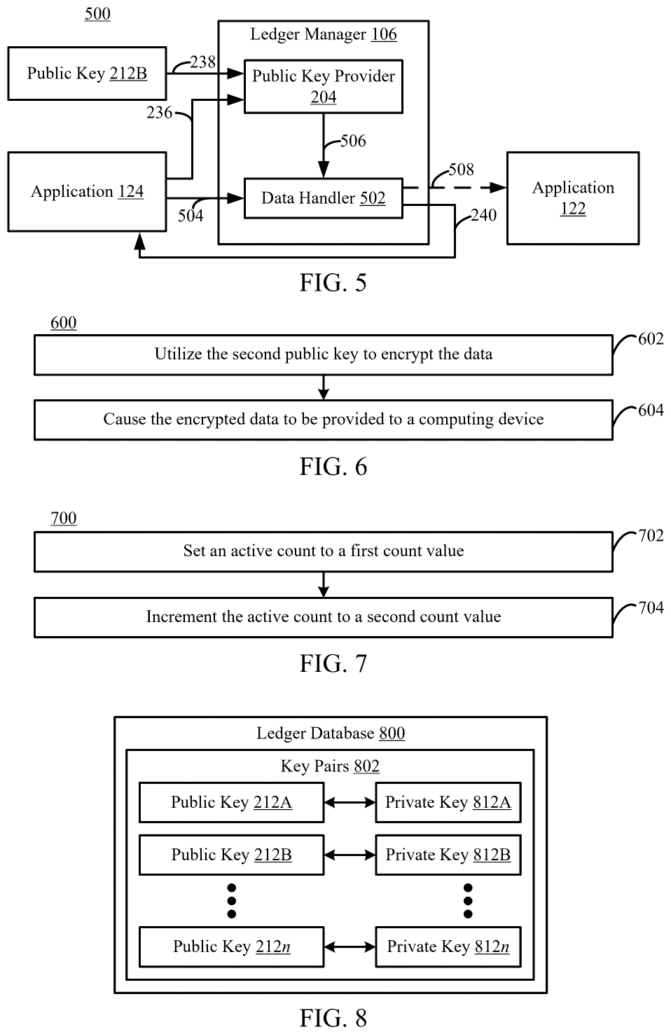

In step 314, responsive to receiving the first active key request, first data accessible to the first application is caused to be encrypted using a first public key of a set of public keys. For example, public key provider 204 of obtains the active public key of public keys 118 from ledger database 116 via key signal 226. As a non-limiting running example, suppose the active key is public key 212A. Public key provider 204 causes data accessible to application 124 (e.g., data to be encrypted or a message to be encrypted) to be encrypted utilizing public key 212A. In accordance with an embodiment, and as further described with respect to FIGS. 5 and 6 (as well as elsewhere herein), public key provider 204 (or another component of ledger manager 106) encrypts the data or message (e.g., suppose the data was included in active key request 224) utilizing public key 212A and provides the encrypted data to application 124 via response 228, and cause application 124 to provide the encrypted data to application 122 via a message 230. Alternatively, public key provider 204 provides the encrypted data to another application on behalf of application 124 (e.g., via a response to application 122 not shown in FIG. 2). For instance, if the encrypted data or message was intended for application 122, in this alternative, public key provider 204 provides the encrypted version to application 122 on behalf of application 124. By providing encrypted messages on behalf of application 124, such embodiments of ledger manager 106 reduce network traffic, as a message comprising the encrypted message is provided from ledger manager 106 to application 122, rather than a message comprising the encrypted data being provided to application 124 and another separate message comprising the encrypted data being provided to application 122 from application 124. In another alternative, and as described with respect to FIG. 4 (as well as elsewhere herein), public key provider 204 provides public key 212A to application 124 to cause application 124 to encrypt data utilizing public key 212A and provide the encrypted data via message 230 to application 122.

In step 316, an update key request is received from a second application associated with the first user account. For example, ledger updater 202 receives an update key request 232 from application 122. In embodiments, update key request 232 comprises instructions to update (e.g., rotate) the active key of public keys 118. In accordance with an embodiment, update key request 232 indicates which key of public keys 118 to rotate to. For instance, in an embodiment, computing device 102 has rotated the active private key of private keys 208 from private key 210A to private key 210B and indicates in update key request 232 for ledger updater 202 to rotate the active public key to the corresponding public key (i.e., public key 212B). Alternatively, update key request 232 indicates to rotate the keys and ledger updater 202 determines which key to rotate to. In this alternative, ledger updater 202 provides a response (e.g., subsequent to, parallel to, or prior to performing step 318 described further herein) comprising an indication of which public key the active public key is to be (or has been) rotated to.

In step 318, responsive to receiving the update key request, the active key is updated to a second public key of the set of public keys. For example, ledger updater 202 of FIG. 2, responsive to receiving update key request 232, updates the active key of public keys 118 from public key 212A to public key 212B via an update signal 234. In accordance with an embodiment, update signal 234 comprises an indication of which public key the active key is to be rotated to (e.g., an identifier of the public key, a count value corresponding to the public key, and/or the like). Alternatively, update signal 234 causes ledger database 116 to rotate the active key from a public key to another public key. In this alternative context, ledger database 116 provides a response to ledger updater 202 comprising an indication of which public key is the new active key. As described with respect to FIG. 1, some instances of ledger database 116 include multiple instances in a federation or group of instances. In such embodiments, ledger updater 202 updates each instance of ledger database 116 to indicate the new active key.

In some embodiments, ledger updater 202 verifies whether or not update key request 232 is a valid key request. For instance, in accordance with an embodiment, ledger updater 202 is configured to require attestation that application 122 has access to more than one private key of private keys 208 (including the currently active private key, e.g., private key 210A). In accordance with an embodiment, update key request 232 comprises the private keys as proof that application 122 has access to the private keys. In accordance with another embodiment, update key request 232 is signed utilizing the private keys and ledger updater 202 verifies the signatures to determine update key request 232 is valid. In accordance with another embodiment, update request 232 comprises a cryptographic proof that attests possession of the two or more private keys. For instance, in accordance with an embodiment, ledger updater 202 utilizes an algorithm that accepts the cryptographic proof and the corresponding public keys, encrypted versions of the private keys, seed value 206, and/or an active count value to determine application 122 has access to the corresponding private keys. In accordance with a further embodiment, ledger updater 202 comprises a cryptographic proof for each private key application 122 is intending to attest ownership of in order to update public keys 118.

In step 320, a second active key request is received from the first application or a third application. For example, public key provider 204 of FIG. 2 receives an active key request 236 from application 124, in a similar manner as described with respect to receiving active key request 224 in step 312. In an alternative embodiment, public key provider 204 receives active key request 236 from an application of another application (e.g., another application executing on computing device 104, an application executing on another computing device, etc.), not shown in FIG. 2.

In step 322, responsive to receiving the second active key request, the first data or second data accessible to the first or a third application is caused to be encrypted using the second public key. For example, public key provider 204 of FIG. 2, responsive to receiving active key request 236, receives the active key (public key 212B) via signal 238 from ledger database 116 and provides a response 240 to either the requesting application (e.g., application 124 (e.g., as shown in FIG. 2) or the other application described with respect to step 320) or the application the encrypted data is intended for (e.g., application 122). Depending on the implementation, response 240 comprises public key 212B and/or data or messages encrypted utilizing public key 212B. For instance, in embodiments where application 124 receives public key 212B, application 124 encrypts the data or message utilizing public key 212B and provides the encrypted data or message to application 122 via message 242. As another example, in embodiments where application 124 receives data encrypted by ledger 106 (or a component thereof), application 124 provides the encrypted data to application 122 via message 242.

Thus, examples of generating and rotating public keys have been described with respect to FIGS. 2, 3A, and 3B. By generating and storing multiple public keys at once, the active key of the set of public keys can be rotated from one of the public keys to another public key without expending compute resources to generate a new public key. In this context, the time from which a key rotation request is made by a first user (e.g., Bob) and an updated active key is available for another user (e.g., Alice) is reduced. For instance, if private key 210A (e.g., Bob's first private key) corresponding to public key 212A is compromised (e.g., made available to a malicious entity), Bob (or an application or system acting on behalf of Bob) is able to request a key rotation (as described with respect to step 316 of flowchart 310 of FIG. 3B), causing the active key of public keys 218 to be rotated from public key 212A to public key 212B, which corresponds to private key 210B (e.g., Bob's second private key). In accordance with an embodiment, this key rotation is faster than having to generate a new public key responsive to the key request.

Embodiments of ledger manager 106 of FIG. 2 operate in various ways to cause data to be encrypted. For example, some embodiments of ledger manager 106 encrypts data, cause another component of system 200 to encrypt data, and/or enable application 124 to encrypt data. For instance, suppose ledger manager 106 causes application 124 to be able to encrypt data. A non-limiting example of this operation is described with respect to FIG. 4. FIG. 4 shows a flowchart 400 of a process for causing data to be encrypted, in accordance with an example embodiment. In an embodiment, public key provider 204 of FIG. 2 operates according to flowchart 400. Note flowchart 400 need not be performed in all embodiments. In accordance with an embodiment, flowchart 400 is a further embodiment of step 314 or step 322 of flowchart 310 of FIG. 3B. Further structural and operational embodiments will be apparent to persons skilled in the relevant art(s) based on the following description of FIG. 4 with respect to FIG. 2.

Flowchart 400 comprises step 402. In step 402, the second computing device is provided access to the active key. For example, in an embodiment, public key provider 204 of FIG. 2 provides response 228 or response 240 to application 124, each response in this example comprising the respective active key at the time the corresponding request was received. For instance, as described with respect to FIG. 2, response 228 in this example is in response to active key request 224 and comprises public key 212A and response 240 in this example is in response to active key request 236 and comprises public key 212B. By providing application 124 access to the public key in this manner, application 124 is able to encrypt its data and/or messages without exposing the data to ledger manager 106, thereby improving security with respect to its data.

As discussed above, some embodiments of ledger manager 106 encrypt data. Such embodiments of ledger manager 106 are configured in various ways to encrypt data. For instance, FIG. 5 shows a block diagram of a system 500 for causing data to be encrypted, in accordance with another example embodiment. As shown in FIG. 5, system 500 comprises ledger manager 106, application 122, and application 124, as described with respect to FIG. 1, and public key 212B, as described with respect to FIG. 2. As also shown in FIG. 5, ledger manager 106 comprises public key provider 204 (as described with respect to FIG. 2) and a data handler 502. Data handler 502 is configured to handle data and/or keys on behalf of an application. For instance, in FIG. 5, data handler 502 handles data (that is to be sent to application 122) and public key 212B on behalf of application 124. While data handler 502 is shown as a sub-component of ledger manager 106, in some embodiments, data handler 502 is a separate component of system 500. For instance, in a non-limiting example, ledger manager 106 is not trusted by application 124 to handle unencrypted versions of data. In this context, data handler 502 is a trusted data handler separate from ledger manager 106.

To better understand the operation of ledger manager 106 comprising data handler 502, FIG. 5 is described with respect to FIG. 6. FIG. 6 shows a flowchart 600 of a process for causing data to be encrypted, in accordance with another example embodiment. In an embodiment, ledger manager 106 of FIG. 5 operates according to flowchart 600. Note not all steps of flowchart 600 need be performed in all embodiments. Further structural and operational embodiments will be apparent to persons skilled in the relevant art(s) based on the following descriptions of FIGS. 5 and 6.

Flowchart 600 begins with step 602. In step 602, the second public key is utilized to encrypt the data. For example, in an embodiment and in response to receiving active key request 236 (e.g., as described with respect to step 320 of flowchart 300 of FIG. 3) and obtaining public key 212B (e.g., as described with respect to step 322 of flowchart 300 of FIG. 3), public key provider 204 of FIG. 5 provides a key signal 506 to data handler 502, wherein key signal 506 comprises public key 212B. As also shown in FIG. 5, data handler 502 receives data 504 from application 124, where data 504 is the data to be encrypted utilizing public key 212B. In an alternative embodiment, data 504 is included in active key request 236.

In step 604, the encrypted data is caused to be provided to a computing device. For example, data handler 502 of FIG. 5 provides response 240 to application 124, response 240 comprising the encrypted version of data 504. Alternatively, or additionally, and as shown in FIG. 5, data handler 502 provides a message 508 to application 122, message 508 comprising the encrypted version of data 504. In this alternative aspect, data handler 502 providing message 508 alternatively to providing response 240 to application 124 reduces network traffic, as message 508 is provided to the intended destination of the encrypted version of data 504 without requiring separate messages to be sent from data handler 502 to application 124 and then from application 124 to application 122.

Embodiments of ledger updater 202 of FIG. 2 operate in various ways to update an active key. FIG. 7 shows a flowchart 700 of a process for updating an active key, in accordance with an example embodiment. In an embodiment, ledger updater 202 of FIG. 2 operates according to flowchart 700. Note not all steps of flowchart 700 need be performed in all embodiments. Further structural and operational embodiments will be apparent to persons skilled in the relevant art(s) based on the following description of FIG. 7 with respect to FIG. 2.

Flowchart 700 starts with step 702. In step 702, an active count is set to a first count value. For instance, ledger updater 202 of FIG. 2 sets an active count to a first count value. In implementations, ledger updater 202 sets the value of the active count when storing public keys 118 in ledger database 116, responsive to receiving public keys 220 from key generator 112, and/or after confirming storage of public keys 118 in ledger database 116. In accordance with an alternative embodiment, ledger database 116 maintains the active count. In this context, ledger database 116 sets the value of the active count subsequent to storage of public keys 118.

In step 704, the active count is incremented to a second count value. For example, ledger updater 202 of FIG. 2 increments the active count set in step 702 to a second count value. In accordance with an embodiment, ledger updater 202 increments the active count responsive to receiving an update key request 232. In this context, ledger updater 202 causes the active key of public keys 118 to the next key corresponding to the new value of active count. In some embodiments, ledger updater 202 maintains the active count as an indication of which public key is the active key without marking the key as active in ledger database 116. In this context, public key provider 204 accesses the active count value in response to an active key request to determine which public key to obtain from public keys 118.

Embodiments of ledger database 116 have been described as storing public keys 118. In some embodiments, a ledger database stores key pairs (e.g., private keys and their corresponding public keys). Embodiments of such ledger databases are configured in various ways. For example, FIG. 8 shows a block diagram of a ledger database 800, in accordance with an example embodiment. As shown in FIG. 8, ledger database 800 comprises key pairs 802. Key pairs 802 comprise public keys 212A-212n (as described with respect to FIG. 2) and private keys 812A-812n. Each private key stored by ledger database 800 corresponds to a respective one of the public keys stored by ledger database 800. For instance, as shown in FIG. 8, private key 812A corresponds to public key 212A (also referred to as “Key Pair A”), private key 812B corresponds to public key 212B (also referred to as “Key Pair B”), and private key 812n corresponds to public key 212n (also referred to as “Key Pair n”). In accordance with an embodiment key pairs 802 are stored by ledger database 800 as a table. In accordance with an embodiment, private keys 812A-812n are stored in an encrypted format such that access to unencrypted versions of private keys 812A-812n is prevented without utilizing an appropriate decryption key. In accordance with an embodiment, the appropriate decryption key is the active key of ledger database 800. In accordance with an alternative embodiment, the appropriate decryption key is a key accessible to ledger manager 106 (or a component thereof) such that ledger manager 106 is able to retrieve and decrypt an active key. In another alternative embodiment, the appropriate decryption key is a key (e.g., only) accessible to the user account key pairs 802 is associated with (e.g., Bob's account associated with computing device 102).

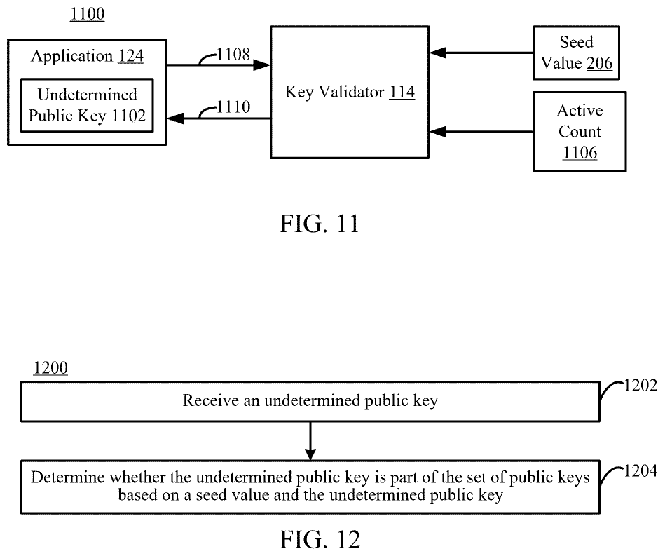

By maintaining private keys in an encrypted state in ledger database 800, embodiments prevent a party accessing (e.g., by a read-only action) ledger database 800 to have access to unencrypted versions of private keys. Furthermore, storage of encrypted versions of the private keys in ledger database 800 enables components such as ledger manager 106, key generator 112, and/or key validator 114 to access the encrypted versions (e.g., without having to request the encrypted version from application 122). For instance, as further described with respect to FIGS. 11 and 12, as well as elsewhere herein, key validator 114 in accordance with an embodiment accesses encrypted versions of private keys to validate keys without exposing unencrypted versions to key validator 114, thereby improving security of a user's secrets.

### III. Embodiments for Appending Public Keys to a Ledger Database

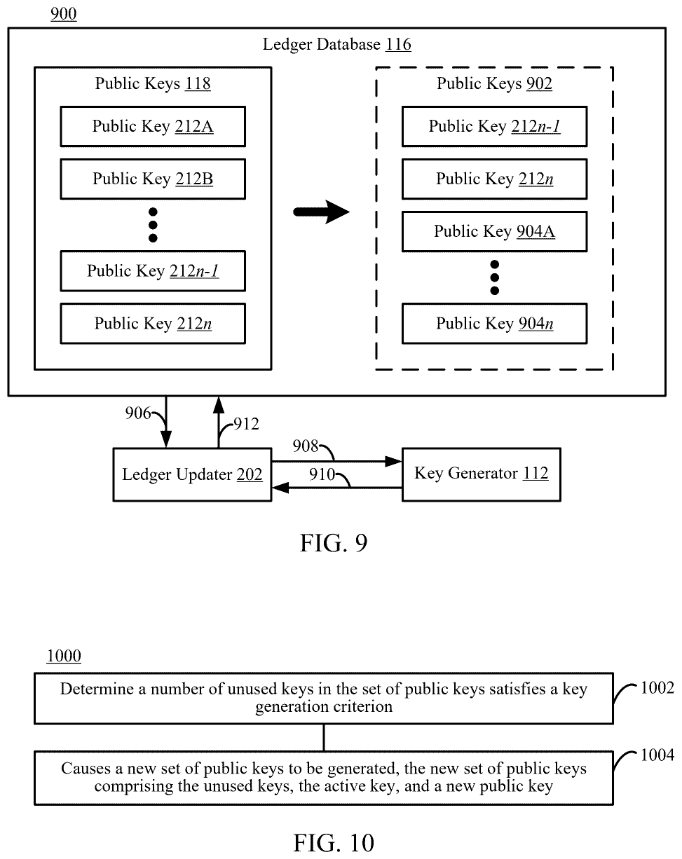

In embodiments, as public keys are refreshed and rotated through, the number of unused keys in ledger database 116 approaches a threshold number (e.g., zero, a number greater than zero (e.g., 1, 2, ones, tens, etc.), etc.). In some embodiments, ledger updater 202 is configured to cause new public keys to be generated. For example, FIG. 9 shows a block diagram of a system 900 for updating a set of keys, in accordance with an example embodiment. As shown in FIG. 9, system 900 comprises key generator 112, ledger database 116, and ledger updater 202, as described with respect to FIG. 2. As also shown in FIG. 9, ledger database 116 comprises public keys 118 (comprising public keys 212A, 212B, 212n-1, and 212n). Furthermore, FIG. 9 is illustrated showing an update of public keys stored in ledger database 116 from public keys 118 to public keys 902 (comprising public key 212n-1, public key 212n, and public keys 904A-904n). To better understand the process of updating public keys, FIG. 9 is described with respect to FIG. 10. FIG. 10 shows a flowchart 1000 of a process for updating a set of keys, in accordance with an example embodiment. In an embodiment, ledger updater 202 of FIG. 9 operates according to flowchart 1000. Note not all steps of flowchart 1000 need be performed in all embodiments. Further structural and operational embodiments will be apparent to persons skilled in the relevant art(s) based on the following descriptions of FIGS. 9 and 10.

Flowchart 1000 begins with step 1002. In step 1002, a number of unused keys in the set of public keys is determined to satisfy a key generation criterion. For example, ledger updater 202 of FIG. 9 monitors public keys 118 via ledger monitoring signal 906. In embodiments, ledger monitoring signal 906 comprises an indication of how many keys are unused in public keys 118 and/or an indication that the keys is below a threshold number (e.g., as determined by ledger database 116 monitoring the number of keys unused in public keys 118). In accordance with an embodiment wherein ledger monitoring signal 906 indicates how many keys are unused in public keys 118, ledger updater 202 determines whether or not the number satisfies a key generation criterion. The key generation criterion specifies a threshold number of unused keys before new keys are to be generated. For instance, suppose public key 212n-1 is the active key and the key generation criterion specifies a threshold number of 1 unused key. In this example, subsequent to public key 212n-1 being rotated to the active key, ledger updater 202 (or ledger database 116) determines the key generation criterion is satisfied.

In step 1004, a new set of public keys are caused to be generated, the new set of public keys comprising the unused keys, the active key, and a new public key. For example, ledger updater 202 of FIG. 9 causes a new set of public keys 902 (“public keys 902” herein) to be generated subsequent to the determination made in step 1002, public keys 902 comprising public key 212n-1 (the active key), public key 212n (the unused key), and public keys 904A-904n (the new public keys). For instance, as shown in FIG. 9, ledger updater 202 transmits a new key request 908 to key generator 112. Key generator 112 generates one or more new keys 910 responsive to request 908. In embodiments, key generator 112 generates new keys 910 in a similar manner as described with respect to step 304 of flowchart 300 of FIG. 3A. Depending on the implementation, key generator 112 generates new keys 910 based on the same seed value that public keys 118 were generated from (e.g., seed value 206 of FIG. 2) or a different seed value. As shown in FIG. 9, key generator 112 transmits keys 910 to ledger updater 202 and ledger updater 202 updates ledger database 116 via update signal 912. Responsive to receiving update signal 912, ledger database 116 is updated to include public keys 902. In accordance with an embodiment, used keys of public keys 118 (e.g., public key 212A, public key 212B, public key 212n-2 (not shown in FIG. 9), etc.) are still stored by ledger database 116. Alternatively, used keys are deleted subsequent to reception of update signal 912. In another alternative, used keys are deleted subsequent to an amount of time since update signal 912 being received satisfying a delete used keys criterion. In another alternative, used keys are deleted (e.g., from oldest to newest) as storage space utilized by ledger database 116 approaches a threshold size.

By generating a new set of unused keys prior to a request to rotate the last unused key of public keys 118 from an active key, such embodiments of ledger updater 202 and key generator 112 enable new keys to pre-emptively be generated such that key rotation requests can be fulfilled quickly (i.e., without waiting for new key generation). Furthermore, since the currently active key of public keys 118 is included in new public keys 902, current usage of the active public key is not interrupted (e.g., until the public keys are rotated). Still further, in implementations where the older set of keys (e.g., public keys 118) comprises unused keys (e.g., public key 212n in the example described with respect to FIG. 9 and flowchart 1000 of FIG. 10) and the unused keys are included in the new set of keys (e.g., public keys 902), compute resources utilized to generate the unused keys are not wasted since the output of operations utilizing those compute resources (i.e., public keys 118) are not discarded without having been used. In some embodiments, and as shown in FIG. 9, public keys that have already been rotated out (e.g., public keys 212A and 212B) are discarded, reducing the storage space consumed by public keys 902 in ledger database 116.

### IV. Key Validation Embodiments

As described herein, key validator 114 is configured to validate keys. Depending on the implementation, key validator 114 validates a key to determine if it is a correct active public key, to determine if it is a public key within a set of public keys, and/or to determine if it is an unused public key or previously used public key. Key validator 114 is configured in various ways to validate keys, in embodiments. For example, FIG. 11 shows a block diagram of a system 1100 for validating a key, in accordance with an example embodiment. As shown in FIG. 11, system 1100 comprises key validator 114 and application 124, as described with respect to FIG. 1, seed value 206, as described with respect to FIG. 2, and an active count 1106. In accordance with an embodiment, active count 1106 indicates a number associated with the currently active key in the set of public keys. As also shown in FIG. 11, application 124 comprises an undetermined public key 1102. In embodiments, key validator 114 operates to determine if public key 1102 is a public key stored in a ledger database. To better understand the operation of key validator 114, FIG. 11 is described with respect to FIG. 12. FIG. 12 shows a flowchart 1200 of a process for validating a key, in accordance with an example embodiment. In an embodiment, key validator 114 of FIG. 11 operates according to flowchart 1200. Note not all steps of flowchart 1200 need be performed in all embodiments. Further structural and operational embodiments will be apparent to persons skilled in the relevant art(s) based on the following descriptions of FIGS. 11 and 12.

Flowchart 1200 begins with step 1202. In step 1202, an undetermined public key is received. For example, key validator 114 receives a validation request 1108 comprising undetermined public key 1102 from application 124. Undetermined public key 1102, in embodiments, is a public key that application 124 (or a user of application 124) receives or otherwise obtains from another party or from a prior key request. Depending on the implementation, undetermined public key 1102 is a valid key, an outdated key that was previously a valid key, a forged key (e.g., a public key of an attacker entity intending to perform a man-in-the-middle attack), and/or the like. In some embodiments, application 124 provides validation request 1108 to key validator 114 responsive to user interaction. Alternatively, a security function of application 124 causes application 124 to provide validation request 1108 to key validator 114 prior to utilizing undetermined public key 1102 to encrypt data.

In step 1204, whether or not the undetermined public key is part of the set of public keys is determined based on a seed value and the undetermined public key. For example, key validator 114 determines whether or not undetermined public key 1102 is part of a set of public keys (e.g., public keys 118) based on a seed value 206 and the undetermined public key. As shown in FIG. 11, key validator 114 generates a validator response 1110 indicating whether or not undetermined public key 1102 is valid. In embodiments, key validator 114 invokes a validation algorithm that accepts seed value 206 and undetermined public key 1102 as input and determines whether or not undetermined public key 1102 was generated from seed value 206. In some embodiments, and as shown in FIG. 11, key validator 114 utilizes active count 1106 to determine if undetermined public key 1102 is valid. In this manner, key validator 114 is able to determine if undetermined public key 1102 is the current active key. In embodiments, key validator 114 utilizes additional information (e.g., in addition to and/or alternative to seed value 206 and/or active count 1106) to determine if undetermined public key 1102 is valid. Examples of such additional information includes, but is not limited to, a user identifier of the user account corresponding to seed value 206 (e.g., a user identifier of Bob's account), a timestamp of when public keys 118 were generated, a timestamp of the last update to ledger database 116, a timestamp of when undetermined public key 1102 was generated, an identifier of the application that provided application 124 with undetermined public key 1102, an identifier of application 124, and/or any other information usable by key validator 114 for determining the validity of undetermined public key 1102. By determining if the public key is part of a particular set of public keys utilizing a seed value, entities (e.g., users, applications, and/or computing devices) can verify a public key is a valid public key without exposing private information to a third party user.

In accordance with an embodiment, key validator 114 determines if undetermined public key 1102 is a valid key utilizing a zero-trust or limited trust protocol. For example, suppose seed value 206 is an encrypted version of the seed value utilized to generate public keys 118 and/or active count 1106 is an encrypted version of the current value of the active count (e.g., to obscure the value from untrusted entities). In this context, key validator 114 utilizes a zero-trust technique that accepts undetermined public key 1102 as well as the encrypted version(s) of seed value 206 and/or active count 1106 and outputs an indication of whether or not undetermined public key 1102 is valid.

To better understand the operation of system 1100 with respect to flowchart 1200, several non-limiting examples are described as follows. For instance, in a first non-limiting example, suppose Alice is utilizing application 124 and receives undetermined public key 1102 from Charlie posing as Bob. Alice believes undetermined public key 1102 is Bob's public key; however, Alice interacts with application 124 to cause (or a security function of application 124 invoked prior to utilization of undetermined public key 1102 causes) validation request 1108 comprising undetermined public key 1102 to be transmitted to key validator 114. In this example, key validator 114 determines undetermined public key 1102 is not a public key of public keys 118 based on seed value 206 (and optionally active count 1106), as described with respect to step 1202. As undetermined public key 1102 was not generated utilizing seed value 206, key validator 114 generates validator response 1110 indicating undetermined public key 1102 is not a valid public key of public keys 118. In this manner, application 124 (or Alice reviewing information generated by application 124) is able to determine the key Charlie's application provided is invalid. In some embodiments, key validator 114 automatically generates an indication to the user account seed value 206 corresponds to (e.g., Bob) to indicate an attempt to forge Bob's public key was made. In another embodiment, application 124, subsequent to receiving validator response 1110 indicating undetermined public key 1102 was not validated and not generated from Bob's seed value, adds Charlie's application to a blacklist or a potential malicious entity list.

In a second non-limiting example, key validator 114 determines whether or not undetermined public key 1102 is valid based on the value of active count 1106. In this context, key validator 114 can detect if a public key is the active key, an outdated key (e.g., it is a previously used public key of the set of public keys), a key otherwise not in use (e.g., previously used or not active at this time), or a key that is not within the set of public keys. For instance, in the second non-limiting example, suppose Charlie has access to a previously active public key and private key of Bob's and has forged a message to Alice comprising the previously active public key (undetermined public key 1102 in the context of this example) posed as Bob's active public key. In this example, application 124 provides validation request 1108 comprising undetermined public key 1102 to key validator 114. Key validator 114 determines whether or not undetermined public key 1102 is Bob's active key based on undetermined public key 1102, seed value 206, and active count 1106. As undetermined public key 1102 is not Bob's active key (even though it was generated with seed value 206), key validator 114 generates validator response 1110 indicating undetermined public key 1102 is not a valid public key of public keys 118 (as it is not the active key). In this manner, application 124 (or Alice reviewing information generated by application 124) is able to determine the key Charlie's application provided is invalid. In accordance with an embodiment, validator response 1110 indicates undetermined public key 1102 is outdated. In this example, Alice (or application 124) can request a new public key in a manner as described with respect to FIG. 3B, or elsewhere herein.

In a third non-limiting example, suppose Alice (or application 124) received undetermined public key 1102 from public key provider 204 (e.g., in response to a previous request for an active key). In this example, application 124 is determining whether or not undetermined public key 1102 is still a valid key (e.g., if it is still the active key for Bob's user account). If key validator 114 determines it is, application 124 proceeds to utilize undetermined public key 1102 (now determined to be active) to encrypt data and provide to Bob's computing device (e.g., computing device 102). If key validator 114 determines the key is no longer valid (e.g., based on the value of active count 1106 being a different value than the value corresponding to undetermined public key 1102), a new public key is issued to application 124. For instance, application 124 issues an active key request to public key provider 204 for the active key responsive to receiving validator response 1110 indicating undetermined public key 1102 is outdated. Alternatively, key validator 114 in accordance with an embodiment causes public key provider 204 of FIG. 2 to provide application 124 with the current active key. In this alternative aspect, key validator 114 conserves compute resources as application 124 does not have to issue a request for a new key, as the new key is requested by key validator 114 automatically.

In the context of the third non-limiting example, a fourth non-limiting example is described. In this example, suppose undetermined public key 1102 is the active public key for Bob's account. Furthermore, suppose key validator 114 is implemented as a sub-component/subservice of application 124 or computing device 104. In this context, validity of undetermined public key 1102 is determined with reduced impact on network traffic. For instance, key validator 114 is able to determine the validity of a public key each time application 124 intends to use the key to encrypt data with seed value 206 stored by computing device 104 (e.g., in an encrypted or decrypted format, depending on the implementation) and the current value of active count 1106. In this context, key validator 114 only needs the most current value of active count 1106 to determine the validity. Depending on the implementation, key validator 114 receives active count 1106 each time a key's validity is to be determined or each time ledger updater 202 updates the value of active count 1106.

### V. Embodiments for Updating a Verifiable Identity Map

Embodiments of the present disclosure operate in a manner to reduce risk of a user's secrets (e.g., private data, private keys, encrypted messages, and/or the like) being exposed to a malicious entity, e.g., via man-in-the-middle attacks or other hacking/cyber-attack activities. Furthermore, in some embodiments, a ledger database (e.g., a different ledger database from the ledger utilized to store keys/key pairs) is utilized to store mappings of identities of user accounts to respective active public keys of the user accounts in an “identity map.” Such systems are configured in various ways to update and/or maintain the identity map, in embodiments. For example, FIG. 13 shows a block diagram of a system 1300 for updating an active key and a verifiable identity map, in accordance with an example embodiment. As shown in FIG. 13, system 1300 comprises application 122 and ledger updater 202, as described with respect to FIGS. 1 and 2 respectively, as well as a ledger database 1306 and a ledger database 1308. Ledger database 1306 is a further example of ledger database 116. As shown in FIG. 13, ledger database 1306 comprises key pairs 1310 (which includes key pairs 1312A, 1312B, and 1312n) and ledger database 1308 comprises an identity map 1314 (also referred to as a verifiable identity map or a “VIM”). While ledger databases 1306 and 1308 are shown as separate databases in FIG. 13, in an alternative embodiment, key pairs 1310 and identity map 1314 are stored by the same ledger database.

As shown in FIG. 13, ledger updater 202 comprises a key DB updater 1302 and a VIM updater 1304, each of which are implemented as sub-services and/or sub-components of ledger updater 202. Key DB updater 1302 is configured to update key pairs 1310 of ledger database 1306 and VIM updater 1304 is configured to update identity map 1314.

Identity map 1314 is configured to store identities 1316A-1316n for a plurality of entities (e.g., users (e.g., individual users, family users, groups of users, and/or the like) or organization. Each of identities 1316A-1316n comprises information that uniquely identifies the entity. Examples of the identity include, but are not limited to, the entity's e-mail address, the entity's phone number, the entity's username, or any other type of information that uniquely identifies the entity. Identity map 1314 is also configured to store (e.g., for each entity, for some entities, etc.) active keys for an identity. For instance, as shown in FIG. 13, identity map 1314 stores active keys 1318A-1318n mapped to respective identities of identities 1316A-1316n. To better understand the mapping of active keys to identities, FIG. 13 is described with respect to FIG. 14. FIG. 14 shows a flowchart 1400 of a process for updating an active key and a verifiable identity map, in accordance with an example embodiment. In an embodiment, ledger updater 202 of FIG. 13 operates according to flowchart 1400. Note not all steps of flowchart 1400 need be performed in all embodiments. Further structural and operational embodiments will be apparent to persons skilled in the relevant art(s) based on the following descriptions of FIGS. 13 and 14.

Flowchart 1400 begins with step 1402. In step 1402, the active key pair in a committed key database associated with a first user account is updated. For example, key DB updater 1302 of FIG. 13 receives an update key request 1320 from application 122 (e.g., in a similar manner as described with respect to step 316 of flowchart 310 of FIG. 3B) and updates the active key of key pairs 1310 via an update signal 1322 (e.g., in a similar manner as described with respect to step 318 of flowchart 310). As also shown in FIG. 13, key DB updater 1302 receives response 1324 comprising the active key. For example, suppose the old active key pair was key pair 1312A and the new active pair is key pair 1312B. In this example, response 1324 comprises the public key of key pair 1312B. Key DB updater 1302 provides the public key to VIM updater 1304 via public key signal 1326 comprising the public key of key pair 1312B and flowchart 1400 proceeds to step 1404.

In step 1404, a public key stored in a verifiable identity map associated with the first user account is updated. For example, VIM updater 1304 of FIG. 13 stores the public key within public key signal 1326 in identity map 1314. In this context, identity map 1314 comprises maps of identities to their respective active public keys. For instance, suppose identity 1316A corresponds to the user account of application 122. In this context, VIM updater 1304 updates active key 1318A to the public key of key pair 1312B. By updating verifiable identity map in this manner, requests for active keys can be fulfilled for any number of identities for which active keys are stored in identity map 1314. This provides a centralized database for (e.g., all) user accounts of a service, organization, tenant, and/or other type of entity that maintains identity map 1314 or for which identity map 1314 is maintained on behalf of.

### VI. Further Example Embodiments

### A. Ledger-Less Key Refreshment Embodiment

Embodiments of the present disclosure have been described with respect to storing multiple public keys in a ledger database. However, in some embodiments, a seed and counter are generated/determined and utilized to dynamically generate public keys. In this context, the need to maintain and store a ledger database of multiple public keys is eliminated, thereby reducing storage required to provide key refreshment. Instead, each time keys are to be rotated, the value of the active count is incremented. For instance, a manager service is configured in a similar manner to ledger manager 106 with the following differences. For instance, the manager service (in accordance with an embodiment) does not maintain a ledger database comprising a key database (i.e., a database of multiple public keys associated with a user account). Furthermore, the manager service receives an active key request (e.g., from an application of another user account). Responsive to the active key request, the manager service generates a public key corresponding to the active private key based on a value of the active count and the seed value. The manager service causes data to be encrypted with the generated public key. In this context, the storage space required to implement key refreshment is reduced, as a ledger database comprising multiple public keys is not needed. Furthermore, manager service in this example may be implemented as a sub-service on a user's computing device.

### B. Embodiments for Supporting Multiple Requesting Users

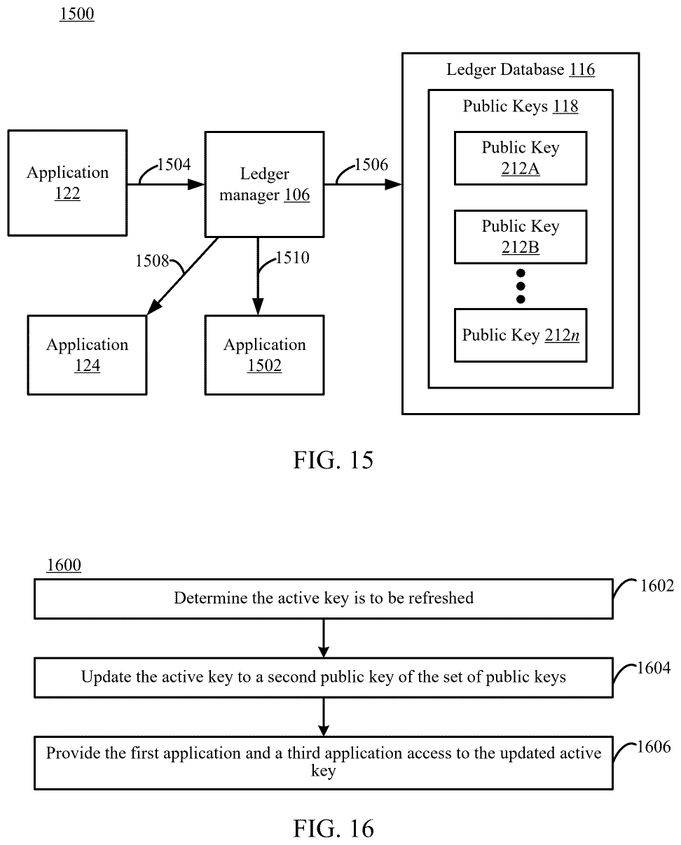

Example embodiments have been described herein where a first user associated with an application (e.g., application 124 of FIG. 1) is requesting a public key of a second user associated with a different application (e.g., application 122 of FIG. 1). In this context, embodiments support providing the first user a public key of the second user. Furthermore, such embodiments support any number of users requesting a public key of the second user. For instance, a system in accordance with an embodiment provides new keys responsive to key update requests and/or in accordance with a refresh schedule to multiple users. Embodiments of such systems are configurable in various ways. For example, FIG. 15 shows a block diagram of a system 1500 for supporting key refresh with respect to multiple requesting users, in an example embodiment. As shown in FIG. 15, system 1500 comprises ledger manager 106, ledger database 116 (comprising public keys 118 (comprising public keys 212A-212n)), application 122, and application 124, as described with respect to FIGS. 1 and 2, as well as an application 1502. Application 1502 is an application executed by a computing device separate from computing devices 102 and 104 (not shown in FIG. 15 for brevity). In accordance with an embodiment, application 1502 is associated with a user that intends to utilize a public key managed by ledger database 116 (e.g., in order to send encrypted data and/or messages to the user associated with computing device 102 and/or application 122). In accordance with an embodiment, the user associated with application 1502 is different from the respective users associated with applications 122 and 124.

In order to better understand the operation of system 1500, FIG. 15 is described with respect to FIG. 16. FIG. 16 shows a flowchart 1600 of a process for providing access to a refreshed key to multiple requesting users, in an example embodiment. In accordance with an embodiment, ledger manager 106 of FIG. 15 operates according to flowchart 1600. Note not all steps of flowchart 1600 need be performed in all embodiments. Further structural and operational embodiments will be apparent to persons skilled in the relevant art(s) based on the following descriptions of FIGS. 15 and 16.

Flowchart 1600 begins with step 1602. In step 1602, the active key is determined to be refreshed. For example, ledger manager 106 of FIG. 15 determines an active key of public keys 118 is to be refreshed. Depending on the implementation, ledger manager 106 determines the active key is to be refreshed based on a refresh schedule (e.g., where an active key is refreshed after a predetermined period of time since the last refresh of the active key, at a fixed interval since the last scheduled refresh (e.g., not including manual refreshes of the active key), and/or the like), based on an update key request, and/or the like. For instance, as shown in FIG. 15, ledger manager 106 receives an update key request 1504 from application 122. Update key request 1504 is a further example of update key request 232 of FIG. 2, in an embodiment.

In step 1604, the active key is updated to a second public key of the set of public keys. For example, ledger manager 106 of FIG. 15 updates the active key of public keys 118 via an update signal 1506. For instance, as a non-limiting running example, suppose the active key is public key 212A. In this context, ledger manager 106 transmits update signal 1506 to public keys 118 to update the active key from public key 212A to public key 212B. Alternatively or additionally, ledger manager 106 causes the active key to be updated in a similar manner as described with respect to other embodiments described herein.

In step 1606, the first application and a third application are provided access to the updated active key. For example, ledger manager 106 of FIG. 15 provides applications 124 and 1502 access to the updated active key (e.g., public key 212B in the running example described with respect to step 1604). As shown in FIG. 15, ledger manager 106 provides the active key to application 124 via an active key signal 1508 and to application 1502 via an active key signal 1510. In accordance with an embodiment, ledger manager 106 provides active key signal 1508 to application 124 and//or active key signal 1510 to application 1502 responsive to (or otherwise subsequent to) updating the active key of public keys 118. In accordance with an alternative embodiment, ledger manager 106 provides active key signal 1508 to application 124 responsive to an active key request received from application 124 (not shown in FIG. 15) and provides active key signal 1510 to application 1502 responsive to an active key request received from application 1502 (not shown in FIG. 15).

### C. Cryptographic Key Protocol Embodiments

Example embodiments have been described herein with respect to encryption keys. For instance, active key 120 of public keys 118 of FIG. 1 has been described as an public encryption key of a user account associated with application 122. However, embodiments described herein are not limited to refreshing encryption keys. In alternative or additional embodiments, implementations of ledger managers and ledger databases enable key refresh of public (and private) keys utilized in other cryptographic protocols, including, but not limited to, authentication protocols, data integrity protocols, and/or other cryptographic protocols. For example, in some embodiments, a ledger manager causes a cryptographic operation to be performed utilizing the active key. The cryptographic operation comprises an operation to encrypt data (e.g., as described with respect to steps 314 and 322 of flowchart 310 of FIG. 3B, as well as elsewhere herein), an operation to authenticate a digital signature (e.g., utilizing a public key corresponding to a private signing key utilized to generate the digital signature), an operation to verify integrity of data, and/or any other type of cryptographic operation utilizing public and corresponding private keys.

### VII. Example Computer System Implementation

Embodiments of network adapter-based smart streaming described herein are implemented in hardware, or hardware combined with one or both of software and/or firmware. For example, ledger manager 106, DB host 110, key generator 112, key validator 114, ledger application 122, application 124, ledger updater 202, public key provider 204, verifier 214, data handler 504, ledger database 800, key DB updater 1302, VIM updater 1304, ledger database 1306, ledger database 1308, application 1502, and/or the components described therein, and/or the steps of flowcharts 300, 310, 400, 600, 700, 1000, 1200, 1400, and/or 1600, are each implemented as computer program code/instructions configured to be executed in one or more processors and stored in a computer readable storage medium. Alternatively, computing device 102, computing device 104, ledger manager 106, DB host 110, key generator 112, key validator 114, system 200, system 500, ledger database 800, system 900, system 1100, ledger database 1306, ledger database 1308, system 1500, and/or the components described therein, and/or the steps of flowcharts 300, 310, 400, 600, 700, 1000, 1200, 1400 and/or 1600 are implemented in one or more SoCs (system on chip). An SoC includes an integrated circuit chip that includes one or more of a processor (e.g., a central processing unit (CPU), microcontroller, microprocessor, digital signal processor (DSP), etc.), memory, one or more communication interfaces, and/or further circuits, and optionally executes received program code and/or include embedded firmware to perform functions.

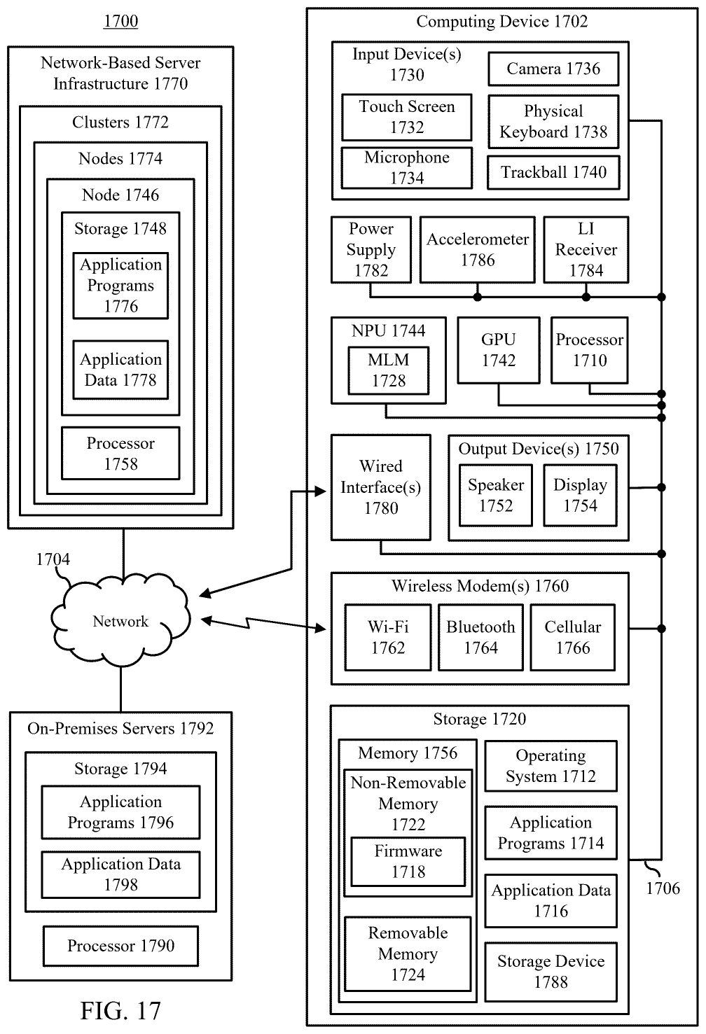

Embodiments disclosed herein can be implemented in one or more computing devices that are mobile (a mobile device) and/or stationary (a stationary device) and include any combination of the features of such mobile and stationary computing devices. Examples of computing devices in which embodiments are implementable are described as follows with respect to FIG. 17. FIG. 17 shows a block diagram of an exemplary computing environment 1700 that includes a computing device 1702. Computing device 1702 is an example of computing device 102, computing device 104, ledger manager 106, DB host 110, key generator 112, and/or key validator 114, which each include one or more of the components of computing device 1702. In some embodiments, computing device 1702 is communicatively coupled with devices (not shown in FIG. 17) external to computing environment 1700 via network 1704. Network 1704 is an example of network 128. Network 1704 comprises one or more networks such as local area networks (LANs), wide area networks (WANs), enterprise networks, the Internet, etc. In examples, network 1704 includes one or more wired and/or wireless portions. In some examples, network 1704 additionally or alternatively includes a cellular network for cellular communications. Computing device 1702 is described in detail as follows.

Computing device 1702 can be any of a variety of types of computing devices. Examples of computing device 1702 include a mobile computing device such as a handheld computer (e.g., a personal digital assistant (PDA)), a laptop computer, a tablet computer, a hybrid device, a notebook computer, a netbook, a mobile phone (e.g., a cell phone, a smart phone, etc.), a wearable computing device (e.g., a head-mounted augmented reality and/or virtual reality device including smart glasses), or other type of mobile computing device. In an alternative example, computing device 1702 is a stationary computing device such as a desktop computer, a personal computer (PC), a stationary server device, a minicomputer, a mainframe, a supercomputer, etc.

As shown in FIG. 17, computing device 1702 includes a variety of hardware and software components, including a processor 1710, a storage 1720, a graphics processing unit (GPU) 1742, a neural processing unit (NPU) 1744, one or more input devices 1730, one or more output devices 1750, one or more wireless modems 1760, one or more wired interfaces 1780, a power supply 1782, a location information (LI) receiver 1784, and an accelerometer 1786. Storage 1720 includes memory 1756, which includes non-removable memory 1722 and removable memory 1724, and a storage device 1788. Storage 1720 also stores an operating system 1712, application programs 1714, and application data 1716. Wireless modem(s) 1760 include a Wi-Fi modem 1762, a Bluetooth modem 1764, and a cellular modem 1766. Output device(s) 1750 includes a speaker 1752 and a display 1754. Input device(s) 1730 includes a touch screen 1732, a microphone 1734, a camera 1736, a physical keyboard 1738, and a trackball 1740. Not all components of computing device 1702 shown in FIG. 17 are present in all embodiments, additional components not shown may be present, and in a particular embodiment any combination of the components are present. In examples, components of computing device 1702 are mounted to a circuit card (e.g., a motherboard (e.g., motherboard 1400)) of computing device 1702, integrated in a housing of computing device 1702, or otherwise included in computing device 1702. The components of computing device 1702 are described as follows.

In embodiments, a single processor 1710 (e.g., central processing unit (CPU), microcontroller, a microprocessor, signal processor, ASIC (application specific integrated circuit), and/or other physical hardware processor circuit) or multiple processors 1710 are present in computing device 1702 for performing such tasks as program execution, signal coding, data processing, input/output processing, power control, and/or other functions. In examples, processor 1710 is a single-core or multi-core processor, and each processor core is single-threaded or multithreaded (to provide multiple threads of execution concurrently). Processor 1710 is configured to execute program code stored in a computer readable medium, such as program code of operating system 1712 and application programs 1714 stored in storage 1720. The program code is structured to cause processor 1710 to perform operations, including the processes/methods disclosed herein. Operating system 1712 controls the allocation and usage of the components of computing device 1702 and provides support for one or more application programs 1714 (also referred to as “applications” or “apps”). In examples, application programs 1714 include common computing applications (e.g., e-mail applications, calendars, contact managers, web browsers, messaging applications), further computing applications (e.g., word processing applications, mapping applications, media player applications, productivity suite applications), one or more machine learning (ML) models, as well as applications related to the embodiments disclosed elsewhere herein. In examples, processor(s) 1710 includes one or more general processors (e.g., CPUs) configured with or coupled to one or more hardware accelerators, such as one or more NPUs 1744 and/or one or more GPUs 1742.

Any component in computing device 1702 can communicate with any other component according to function, although not all connections are shown for ease of illustration. For instance, as shown in FIG. 17, bus 1706 is a multiple signal line communication medium (e.g., conductive traces in silicon, metal traces along a motherboard, wires, etc.) present to communicatively couple processor 1710 to various other components of computing device 1702, although in other embodiments, an alternative bus, further buses, and/or one or more individual signal lines is/are present to communicatively couple components. Bus 1706 represents one or more of any of several types of bus structures, including a memory bus or memory controller, a peripheral bus, an accelerated graphics port, and a processor or local bus using any of a variety of bus architectures.

Storage 1720 is physical storage that includes one or both of memory 1756 and storage device 1788, which store operating system 1712, application programs 1714, and application data 1716 according to any distribution. Non-removable memory 1722 includes one or more of RAM (random access memory), ROM (read only memory), flash memory, a solid-state drive (SSD), a hard disk drive (e.g., a disk drive for reading from and writing to a hard disk), and/or other physical memory device type. In examples, non-removable memory 1722 includes main memory and is separate from or fabricated in a same integrated circuit as processor 1710. As shown in FIG. 17, non-removable memory 1722 stores firmware 1718 that is present to provide low-level control of hardware. Examples of firmware 1718 include BIOS (Basic Input/Output System, such as on personal computers) and boot firmware (e.g., on smart phones). In examples, removable memory 1724 is inserted into a receptacle of or is otherwise coupled to computing device 1702 and can be removed by a user from computing device 1702. Removable memory 1724 can include any suitable removable memory device type, including an SD (Secure Digital) card, a Subscriber Identity Module (SIM) card, which is well known in GSM (Global System for Mobile Communications) communication systems, and/or other removable physical memory device type. In examples, one or more of storage device 1788 are present that are internal and/or external to a housing of computing device 1702 and are or are not removable. Examples of storage device 1788 include a hard disk drive, a SSD, a thumb drive (e.g., a USB (Universal Serial Bus) flash drive), or other physical storage device.

One or more programs are stored in storage 1720. Such programs include operating system 1712, one or more application programs 1714, and other program modules and program data. Examples of such application programs include computer program logic (e.g., computer program code/instructions) for implementing ledger manager 106, DB host 110, key generator 112, key validator 114, ledger application 122, application 124, ledger updater 202, public key provider 204, verifier 214, data handler 504, ledger database 800, key DB updater 1302, VIM updater 1304, ledger database 1306, ledger database 1308, application 1502, and/or the components described therein, and/or the steps of flowcharts 300, 310, 400, 600, 700, 1000, 1200, 1400, and/or 1600.

Storage 1720 also stores data used and/or generated by operating system 1712 and application programs 1714 as application data 1716. Examples of application data 1716 include web pages, text, images, tables, sound files, video data, and other data. In examples, application data 1716 is sent to and/or received from one or more network servers or other devices via one or more wired or wireless networks. Storage 1720 can be used to store further data including a subscriber identifier, such as an International Mobile Subscriber Identity (IMSI), and an equipment identifier, such as an International Mobile Equipment Identifier (IMEI). Such identifiers can be transmitted to a network server to identify users and equipment.

In examples, a user enters commands and information into computing device 1702 through one or more input devices 1730 and receives information from computing device 1702 through one or more output devices 1750. Input device(s) 1730 includes one or more of touch screen 1732, microphone 1734, camera 1736, physical keyboard 1738 and/or trackball 1740 and output device(s) 1750 includes one or more of speaker 1752 and display 1754. Each of input device(s) 1730 and output device(s) 1750 are integral to computing device 1702 (e.g., built into a housing of computing device 1702) or are external to computing device 1702 (e.g., communicatively coupled wired or wirelessly to computing device 1702 via wired interface(s) 1780 and/or wireless modem(s) 1760). Further input devices 1730 (not shown) can include a Natural User Interface (NUI), a pointing device (computer mouse), a joystick, a video game controller, a scanner, a touch pad, a stylus pen, a voice recognition system to receive voice input, a gesture recognition system to receive gesture input, or the like. Other possible output devices (not shown) can include piezoelectric or other haptic output devices. Some devices can serve more than one input/output function. For instance, display 1754 displays information, as well as operating as touch screen 1732 by receiving user commands and/or other information (e.g., by touch, finger gestures, virtual keyboard, etc.) as a user interface. Any number of each type of input device(s) 1730 and output device(s) 1750 are present, including multiple microphones 1734, multiple cameras 1736, multiple speakers 1752, and/or multiple displays 1754.

In embodiments where GPU 1742 is present, GPU 1742 includes hardware (e.g., one or more integrated circuit chips that implement one or more of processing cores, multiprocessors, compute units, etc.) configured to accelerate computer graphics (two-dimensional (2D) and/or three-dimensional (3D)), perform image processing, and/or execute further parallel processing applications (e.g., training of neural networks, etc.). Examples of GPU 1742 perform calculations related to 3D computer graphics, include 2D acceleration and framebuffer capabilities, accelerate memory-intensive work of texture mapping and rendering polygons, accelerate geometric calculations such as the rotation and translation of vertices into different coordinate systems, support programmable shaders that manipulate vertices and textures, perform oversampling and interpolation techniques to reduce aliasing, and/or support very high-precision color spaces.

In examples, NPU 1744 (also referred to as an “artificial intelligence (AI) accelerator” or “deep learning processor (DLP)”) is a processor or processing unit configured to accelerate artificial intelligence and machine learning applications, such as execution of machine learning (ML) model (MLM) 1728. In an example, NPU 1744 is configured for a data-driven parallel computing and is highly efficient at processing massive multimedia data such as videos and images and processing data for neural networks. NPU 1744 is configured for efficient handling of AI-related tasks, such as speech recognition, background blurring in video calls, photo or video editing processes like object detection, etc.

In embodiments disclosed herein that implement ML models, NPU 1744 can be utilized to execute such ML models, of which MLM 1728 is an example. For instance, where applicable, MLM 1728 is a generative AI model that generates content that is complex, coherent, and/or original. For instance, a generative AI model can create sophisticated sentences, lists, ranges, tables of data, images, essays, and/or the like. An example of a generative AI model is a language model. A language model is a model that estimates the probability of a token or sequence of tokens occurring in a longer sequence of tokens. In this context, a “token” is an atomic unit that the model is training on and making predictions on. Examples of a token include, but are not limited to, a word, a character (e.g., an alphanumeric character, a blank space, a symbol, etc.), a sub-word (e.g., a root word, a prefix, or a suffix). In other types of models (e.g., image based models) a token may represent another kind of atomic unit (e.g., a subset of an image). Examples of language models applicable to embodiments herein include large language models (LLMs), text-to-image AI image generation systems, text-to-video AI generation systems, etc. A large language model (LLM) is a language model that has a high number of model parameters. In examples, an LLM has millions, billions, trillions, or even greater numbers of model parameters. Model parameters of an LLM are the weights and biases the model learns during training. Some implementations of LLMs are transformer-based LLMs (e.g., the family of generative pre-trained transformer (GPT) models). A transformer is a neural network architecture that relies on self-attention mechanisms to transform a sequence of input embeddings into a sequence of output embeddings (e.g., without relying on convolutions or recurrent neural networks).

In further examples, NPU 1744 is used to train MLM 1728. To train MLM 1728, training data is that includes input features (attributes) and their corresponding output labels/target values (e.g., for supervised learning) is collected. A training algorithm is a computational procedure that is used so that MLM 1728 learns from the training data. Parameters/weights are internal settings of MLM 1728 that are adjusted during training by the training algorithm to reduce a difference between predictions by MLM 1728 and actual outcomes (e.g., output labels). In some examples, MLM 1728 is set with initial values for the parameters/weights. A loss function measures a dissimilarity between predictions by MLM 1728 and the target values, and the parameters/weights of MLM 1728 are adjusted to minimize the loss function. The parameters/weights are iteratively adjusted by an optimization technique, such as gradient descent. In this manner, MLM 1728 is generated through training by NPU 1744 to be used to generate inferences based on received input feature sets for particular applications. MLM 1728 is generated as a computer program or other type of algorithm configured to generate an output (e.g., a classification, a prediction/inference) based on received input features, and is stored in the form of a file or other data structure.

In examples, such training of MLM 1728 by NPU 1744 is supervised or unsupervised. According to supervised learning, input objects (e.g., a vector of predictor variables) and a desired output value (e.g., a human-labeled supervisory signal) train MLM 1728. The training data is processed, building a function that maps new data on expected output values. Example algorithms usable by NPU 1744 to perform supervised training of MLM 1728 in particular implementations include support-vector machines, linear regression, logistic regression, Naïve Bayes, linear discriminant analysis, decision trees, K-nearest neighbor algorithm, neural networks, and similarity learning.

In an example of supervised learning where MLM 1728 is an LLM, MLM 1728 can be trained by exposing the LLM to (e.g., large amounts of) text (e.g., predetermined datasets, books, articles, text-based conversations, webpages, transcriptions, forum entries, and/or any other form of text and/or combinations thereof). In examples, training data is provided from a database, from the Internet, from a system, and/or the like. Furthermore, an LLM can be fine-tuned using Reinforcement Learning with Human Feedback (RLHF), where the LLM is provided the same input twice and provides two different outputs and a user ranks which output is preferred. In this context, the user's ranking is utilized to improve the model. Further still, in example embodiments, an LLM is trained to perform in various styles, e.g., as a completion model (a model that is provided a few words or tokens and generates words or tokens to follow the input), as a conversation model (a model that provides an answer or other type of response to a conversation-style prompt), as a combination of a completion and conversation model, or as another type of LLM model.

According to unsupervised learning, MLM 1728 is trained to learn patterns from unlabeled data. For instance, in embodiments where MLM 1728 implements unsupervised learning techniques, MLM 1728 identifies one or more classifications or clusters to which an input belongs. During a training phase of MLM 1728 according to unsupervised learning, MLM 1728 tries to mimic the provided training data and uses the error in its mimicked output to correct itself (i.e., correct weights and biases). In further examples, NPU 1744 perform unsupervised training of MLM 1728 according to one or more alternative techniques, such as Hopfield learning rule, Boltzmann learning rule, Contrastive Divergence, Wake Sleep, Variational Inference, Maximum Likelihood, Maximum A Posteriori, Gibbs Sampling, and backpropagating reconstruction errors or hidden state reparameterizations.

Note that NPU 1744 need not necessarily be present in all ML model embodiments. In embodiments where ML models are present, any one or more of processor 1710, GPU 1742, and/or NPU 1744 can be present to train and/or execute MLM 1728.

One or more wireless modems 1760 can be coupled to antenna(s) (not shown) of computing device 1702 and can support two-way communications between processor 1710 and devices external to computing device 1702 through network 1704, as would be understood to persons skilled in the relevant art(s). Wireless modem 1760 is shown generically and can include a cellular modem 1766 for communicating with one or more cellular networks, such as a GSM network for data and voice communications within a single cellular network, between cellular networks, or between the mobile device and a public switched telephone network (PSTN). In examples, wireless modem 1760 also or alternatively includes other radio-based modem types, such as a Bluetooth modem 1764 (also referred to as a “Bluetooth device”) and/or Wi-Fi modem 1762 (also referred to as an “wireless adaptor”). Wi-Fi modem 1762 is configured to communicate with an access point or other remote Wi-Fi-capable device according to one or more of the wireless network protocols based on the IEEE (Institute of Electrical and Electronics Engineers) 802.11 family of standards, commonly used for local area networking of devices and Internet access. Bluetooth modem 1764 is configured to communicate with another Bluetooth-capable device according to the Bluetooth short-range wireless technology standard(s) such as IEEE 802.15.1 and/or managed by the Bluetooth Special Interest Group (SIG).

Computing device 1702 can further include power supply 1782, LI receiver 1784, accelerometer 1786, and/or one or more wired interfaces 1780. Example wired interfaces 1780 include a USB port, IEEE 1394 (FireWire) port, a RS-172 port, an HDMI (High-Definition Multimedia Interface) port (e.g., for connection to an external display), a DisplayPort port (e.g., for connection to an external display), an audio port, and/or an Ethernet port, the purposes and functions of each of which are well known to persons skilled in the relevant art(s). Wired interface(s) 1780 of computing device 1702 provide for wired connections between computing device 1702 and network 1704, or between computing device 1702 and one or more devices/peripherals when such devices/peripherals are external to computing device 1702 (e.g., a pointing device, display 1754, speaker 1752, camera 1736, physical keyboard 1738, etc.). Power supply 1782 is configured to supply power to each of the components of computing device 1702 and receives power from a battery internal to computing device 1702, and/or from a power cord plugged into a power port of computing device 1702 (e.g., a USB port, an A/C power port). LI receiver 1784 is useable for location determination of computing device 1702 and in examples includes a satellite navigation receiver such as a Global Positioning System (GPS) receiver and/or includes other type of location determiner configured to determine location of computing device 1702 based on received information (e.g., using cell tower triangulation, etc.). Accelerometer 1786, when present, is configured to determine an orientation of computing device 1702.

Note that the illustrated components of computing device 1702 are not required or all-inclusive, and fewer or greater numbers of components can be present as would be recognized by one skilled in the art. In examples, computing device 1702 includes one or more of a gyroscope, barometer, proximity sensor, ambient light sensor, digital compass, etc. In an example, processor 1710 and memory 1756 are co-located in a same semiconductor device package, such as being included together in an integrated circuit chip, FPGA, or system-on-chip (SOC), optionally along with further components of computing device 1702.

In embodiments, computing device 1702 is configured to implement any of the above-described features of flowcharts herein. Computer program logic for performing any of the operations, steps, and/or functions described herein is stored in storage 1720 and executed by processor 1710.

In some embodiments, server infrastructure 1770 is present in computing environment 1700 and is communicatively coupled with computing device 1702 via network 1704. Server infrastructure 1770, when present, is a network-accessible server set (e.g., a cloud-based environment or platform). As shown in FIG. 17, server infrastructure 1770 includes clusters 1772. Each of clusters 1772 comprises a group of one or more compute nodes and/or a group of one or more storage nodes. For example, as shown in FIG. 17, cluster 1772 includes nodes 1774. Each of nodes 1774 are accessible via network 1704 (e.g., in a “cloud-based” embodiment) to build, deploy, and manage applications and services. In examples, any of nodes 1774 is a storage node that comprises a plurality of physical storage disks, SSDs, and/or other physical storage devices that are accessible via network 1704 and are configured to store data associated with the applications and services managed by nodes 1774.

Each of nodes 1774, as a compute node, comprises one or more server computers, server systems, and/or computing devices. For instance, a node 1774 in accordance with an embodiment includes one or more of the components of computing device 1702 disclosed herein. Each of nodes 1774 is configured to execute one or more software applications (or “applications”) and/or services and/or manage hardware resources (e.g., processors, memory, etc.), which are utilized by users (e.g., customers) of the network-accessible server set. In examples, as shown in FIG. 17, nodes 1774 includes a node 1746 that includes storage 1748 and/or one or more of a processor 1758 (e.g., similar to processor 1710, GPU 1742, and/or NPU 1744 of computing device 1702). Storage 1748 stores application programs 1776 and application data 1778. Processor(s) 1758 operate application programs 1776 which access and/or generate related application data 1778. In an implementation, nodes such as node 1746 of nodes 1774 operate or comprise one or more virtual machines, with each virtual machine emulating a system architecture (e.g., an operating system), in an isolated manner, upon which applications such as application programs 1776 are executed.

In embodiments, one or more of clusters 1772 are located/co-located (e.g., housed in one or more nearby buildings with associated components such as backup power supplies, redundant data communications, environmental controls, etc.) to form a datacenter, or are arranged in other manners. Accordingly, in an embodiment, one or more of clusters 1772 are included in a datacenter in a distributed collection of datacenters. In embodiments, exemplary computing environment 1700 comprises part of a cloud-based platform.

In an embodiment, computing device 1702 accesses application programs 1776 for execution in any manner, such as by a client application and/or a browser at computing device 1702.

In an example, for purposes of network (e.g., cloud) backup and data security, computing device 1702 additionally and/or alternatively synchronizes copies of application programs 1714 and/or application data 1716 to be stored at network-based server infrastructure 1770 as application programs 1776 and/or application data 1778. In examples, operating system 1712 and/or application programs 1714 include a file hosting service client configured to synchronize applications and/or data stored in storage 1720 at network-based server infrastructure 1770.

In some embodiments, on-premises servers 1792 are present in computing environment 1700 and are communicatively coupled with computing device 1702 via network 1704. On-premises servers 1792, when present, are hosted within an organization's infrastructure and, in many cases, physically onsite of a facility of that organization. On-premises servers 1792 are controlled, administered, and maintained by IT (Information Technology) personnel of the organization or an IT partner to the organization. Application data 1798 can be shared by on-premises servers 1792 between computing devices of the organization, including computing device 1702 (when part of an organization) through a local network of the organization, and/or through further networks accessible to the organization (including the Internet). Furthermore, in examples, on-premises servers 1792 serve applications such as application programs 1796 to the computing devices of the organization, including computing device 1702. Accordingly, in examples, on-premises servers 1792 include storage 1794 (which includes one or more physical storage devices such as storage disks and/or SSDs) for storage of application programs 1796 and application data 1798 and include a processor 1790 (e.g., similar to processor 1710, GPU 1742, and/or NPU 1744 of computing device 1702) for execution of application programs 1796. In some embodiments, multiple processors 1790 are present for execution of application programs 1796 and/or for other purposes. In further examples, computing device 1702 is configured to synchronize copies of application programs 1714 and/or application data 1716 for backup storage at on-premises servers 1792 as application programs 1796 and/or application data 1798.

Embodiments described herein may be implemented in one or more of computing device 1702, network-based server infrastructure 1770, and on-premises servers 1792. For example, in some embodiments, computing device 1702 is used to implement systems, clients, or devices, or components/subcomponents thereof, disclosed elsewhere herein. In other embodiments, a combination of computing device 1702, network-based server infrastructure 1770, and/or on-premises servers 1792 is used to implement the systems, clients, or devices, or components/subcomponents thereof, disclosed elsewhere herein.

As used herein, the terms “computer program medium,” “computer-readable medium,” “computer-readable storage medium,” and “computer-readable storage device,” etc., are used to refer to physical hardware media. Examples of such physical hardware media include any hard disk, optical disk, SSD, other physical hardware media such as RAMs, ROMs, flash memory, digital video disks, zip disks, MEMs (microelectronic machine) memory, nanotechnology-based storage devices, and further types of physical/tangible hardware storage media of storage 1720. Such computer-readable media and/or storage media are distinguished from and non-overlapping with communication media, propagating signals, and signals per se. Stated differently, “computer program medium,” “computer-readable medium,” “computer-readable storage medium,” and “computer-readable storage device” do not encompass communication media, propagating signals, and signals per se. Communication media embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared, and other wireless media, as well as wired media. Embodiments are also directed to such communication media that are separate and non-overlapping with embodiments directed to computer-readable storage media.

As noted above, computer programs and modules (including application programs 1714) are stored in storage 1720. Such computer programs can also be received via wired interface(s) 1760 and/or wireless modem(s) 1760 over network 1704. Such computer programs, when executed or loaded by an application, enable computing device 1702 to implement features of embodiments discussed herein. Accordingly, such computer programs represent controllers of the computing device 1702.

Embodiments are also directed to computer program products comprising computer code or instructions stored on any computer-readable medium or computer-readable storage medium. Such computer program products include the physical storage of storage 1720 as well as further physical storage types.

### VIII. Additional Example Embodiments

A system is described herein. The system comprising a processor and memory. The memory stores program code executable by the processor circuit. The program code comprises a ledger manager. The ledger manager: stores, in a ledger database, a set of public keys associated with a first user account; assigns a first public key of the set of public keys as an active key; responsive to receiving an update key request from a first computing device on behalf of the first user account, updates the active key to a second public key of the set of public keys; and causes a cryptographic operation to be performed using the second public key.

In an implementation of the foregoing system, the ledger manager causes the cryptographic operation to be performed responsive to receiving an active key request from a second computing device on behalf of a second user account.

In an implementation of the foregoing system, the ledger manager provides a second computing device associated with a second user account and a third computing device associated with a third user account access to the second public key.

In an implementation of the foregoing system, to cause the cryptographic operation to be performed using the second public key, the ledger manager causes data accessible to the second computing device to be encrypted using the second public key.

In an implementation of the foregoing system, wherein to cause the data to be encrypted, the ledger manager provides the second computing device access to the second public key.

In an implementation of the foregoing system, wherein to cause the data to be encrypted, the ledger manager: utilizes the second public key to encrypt the data; and causes the encrypted data to be provided to the first computing device.

In an implementation of the foregoing system, to cause the cryptographic operation to be performed using the second public key, the ledger manager utilizes the second public key to authenticate a signature.

In an implementation of the foregoing system, to cause the cryptographic operation to be performed using the second public key, the ledger manager utilizes the second public key to verify integrity of first data.

In an implementation of the foregoing system, the system comprises the ledger database.

In an implementation of the foregoing system, the first computing device comprises a first application and the second computing device comprises a second application associated with the first user account.

In an implementation of the foregoing system, the ledger manager: responsive to receiving a second active key request from the second computing device and prior to the first active key request: causes first data accessible to the second computing device to be encrypted using the first public key; and causes the encrypted first data to be provided to the first computing device.

In an implementation of the foregoing system, the ledger database comprises a set of key pairs comprising: the set of public keys; and a set of private keys, wherein each private key of the set of private keys corresponds to a respective public key of the set of public keys.

In an implementation of the foregoing system, the first and second public keys are generated based on a seed value.

In an implementation of the foregoing system, the program code further comprises a key validator that: receives an undetermined public key; and determines whether the undetermined public key is part of the set of public keys based on the seed value and the undetermined public key.

In an implementation of the foregoing system, to determine whether the undetermined public key is part of the set of public keys, the key validator utilizes a zero-knowledge protocol to verify the public key.

In an implementation of the foregoing system, the program code further comprises a key generator that: generates the set of public keys based on the seed value; and stores the set of public keys in the ledger database.

In an implementation of the foregoing system, the key generator further: receives, from the first computing device, the seed value; and generates the set of public keys based on the seed value.

In an implementation of the foregoing system, the first public key is associated with a first count value in a sequence of count values, the second public key is associated with a second count value in the sequence of count values subsequent to the first count value, an active count is set to the first count value, and to update the active key, the ledger manager: increments the active count to the second count value.

In an implementation of the foregoing system, the ledger manager: determines a number of unused keys in the set of public keys satisfies a key generation criterion; and causes a new set of public keys to be generated, the new set of public keys comprising the unused keys, the active key, and a new public key.

A method is described herein. The method comprising: storing, in a ledger database, a set of public keys associated with a first user account; assigning a first public key of the set of public keys as an active key; responsive to receiving an update key request from a first computing device on behalf of the first user account, updating the active key to a second public key of the set of public keys; and causing a cryptographic operation to be performed using the second public key.

In an implementation of the foregoing method, said causing the cryptographic operation to be performed is responsive to receiving an active key request from a second computing device on behalf of a second user account.

In an implementation of the foregoing method, the method further comprises providing a second computing device associated with a second user account and a third computing device associated with a third user account access to the second public key.

In an implementation of the foregoing method, said causing a cryptographic operation comprises causing data accessible to the second computing device to be encrypted using the second public key.

In an implementation of the foregoing method, wherein said causing the data to be encrypted comprises: providing the second computing device access to the second public key.

In an implementation of the foregoing method, wherein said causing the data to be encrypted comprises: utilizing the second public key to encrypt the data; and causing the encrypted data to be provided to the first computing device.

In an implementation of the foregoing method, said causing a cryptographic operation to be performed comprises: utilizing the second public key to authenticate a signature.

In an implementation of the foregoing method, said causing a cryptographic operation to be performed comprises: utilizing the second public key to verify integrity of data.

In an implementation of the foregoing method, wherein the first computing device comprises a first application and the second computing device comprises a second application associated with the first user account.

In an implementation of the foregoing method, the method further comprises: responsive to receiving a second active key request from the second computing device and prior to the first active key request, causing first data accessible to the second computing device to be encrypted using the first public key; and causing the encrypted first data to be provided to the first computing device.

In an implementation of the foregoing method, the ledger database comprises a set of key pairs comprising: the set of public keys; and a set of private keys, wherein each private key of the set of private keys corresponds to a respective public key of the set of public keys.

In an implementation of the foregoing method, the first and second public keys are generated based on a seed value.

In an implementation of the foregoing method, wherein the method further comprises: receiving an undetermined public key; and determining whether the undetermined public key is part of the set of public keys based on the seed value and the undetermined public key.

In an implementation of the foregoing method, wherein said determining whether the undetermined public key is part of the set of public keys comprises utilizing a zero-knowledge protocol to verify the public key.

In an implementation of the foregoing method, wherein the method further comprises: generating the set of public keys based on the seed value; and storing the set of public keys in the ledger database.

In an implementation of the foregoing method, further comprising: receiving, from the first computing device, the seed value; and generating the set of public keys based on the seed value.

In an implementation of the foregoing method, the first public key is associated with a first count value in a sequence of count values, the second public key is associated with a second count value in the sequence of count values subsequent to the first count value, an active count is set to the first count value, and said updating the active key comprises: incrementing the active count to the second count value.

In an implementation of the foregoing method, further comprising: determining a number of unused keys in the set of public keys satisfies a key generation criterion; and causing a new set of public keys to be generated, the new set of public keys comprising the unused keys, the active key, and a new public key.

A computer readable storage medium is described herein. The computer readable storage medium comprising programming instructions encoded thereon. The programming instructions structured to cause a processor to perform any of the foregoing methods.

### IX. Conclusion

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

In the discussion, unless otherwise stated, adjectives modifying a condition or relationship characteristic of a feature or features of an implementation of the disclosure, should be understood to mean that the condition or characteristic is defined to within tolerances that are acceptable for operation of the implementation for an application for which it is intended. Furthermore, if the performance of an operation is described herein as being “in response to” one or more factors, it is to be understood that the one or more factors may be regarded as a sole contributing factor for causing the operation to occur or a contributing factor along with one or more additional factors for causing the operation to occur, and that the operation may occur at any time upon or after establishment of the one or more factors. Still further, where “based on” is used to indicate an effect being a result of an indicated cause, it is to be understood that the effect is not required to only result from the indicated cause, but that any number of possible additional causes may also contribute to the effect. Thus, as used herein, the term “based on” should be understood to be equivalent to the term “based at least on.”

Numerous example embodiments have been described above. Any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

Furthermore, example embodiments have been described above with respect to one or more running examples. Such running examples describe one or more particular implementations of the example embodiments; however, embodiments described herein are not limited to these particular implementations.

Moreover, according to the described embodiments and techniques, any components of systems, applications, computing devices, ledger databases, ledger managers, key generators, key validators, identity maps, and their functions may be caused to be activated for operation/performance thereof based on other operations, functions, actions, and/or the like, including initialization, completion, and/or performance of the operations, functions, actions, and/or the like.

In some example embodiments, one or more of the operations of the flowcharts described herein may not be performed. Moreover, operations in addition to or in lieu of the operations of the flowcharts described herein may be performed. Further, in some example embodiments, one or more of the operations of the flowcharts described herein may be performed out of order, in an alternate sequence, or partially (or completely) concurrently with each other or with other operations.

The embodiments described herein and/or any further systems, sub-systems, devices and/or components disclosed herein may be implemented in hardware (e.g., hardware logic/electrical circuitry), or any combination of hardware with software (computer program code configured to be executed in one or more processors or processing devices) and/or firmware.

While various embodiments have been described above, it should be understood that they have been presented by way of example only, and not limitation. It will be apparent to persons skilled in the relevant art that various changes in form and detail can be made therein without departing from the spirit and scope of the embodiments. Thus, the breadth and scope of the embodiments should not be limited by any of the above-described example embodiments, but should be defined only in accordance with the following claims and their equivalents.

What is claimed is:

1. A system comprising:
a processor;
a ledger database comprising a set of public keys associated with a first user account, a first public key of the set of public keys indicated as an active key; and
a memory that stores program code executable by the processor circuit, the program code comprising:
a ledger manager that:
responsive to receiving a first active key request from a first application, causes a first cryptographic operation to be performed on first data accessible to the first application using the first public key,
causes a result of the first cryptographic operation to be provided to a second application associated with the first user account;
responsive to receiving an update key request from the second application, updates the active key to a second public key of the set of public keys, and
responsive to receiving a second active key request from the first application, causes a second cryptographic operation to be performed on second data accessible to the first application using the second public key; and
causes a result of the second cryptographic operation to be provided to the second application.

2. The system of claim 1, wherein the ledger comprises a set of key pairs comprising:
the set of public keys; and
a set of private keys, wherein each private key of the set of private keys corresponds to a respective public key of the set of public keys.

3. The system of claim 1, wherein the first and second public keys are generated based on a seed value.

4. The system of claim 3, wherein the program code further comprises a key validator that:
receives an undetermined public key; and
determines whether the undetermined public key is part of the set of public keys based on the seed value and the undetermined public key.

5. The system of claim 4, wherein to determine whether the undetermined public key is part of the set of public keys, the key validator:
utilizes a zero-knowledge protocol to verify the public key.

6. The system of claim 3, wherein the program code further comprises a key generator that:
generates the set of public keys based on the seed value; and
stores the set of public keys in the ledger database.

7. The system of claim 6, wherein the key generator further:
receives, from the second application, the seed value; and
generates the set of public keys based on the seed value.

8. The system of claim 1, wherein the first public key is associated with a first count value in a sequence of count values, the second public key is associated with a second count value in the sequence of count values subsequent to the first count value, an active count is set to the first count value, and to update the active key, the ledger manager:
increments the active count to the second count value.

9. The system of claim 1, wherein the ledger manager:
determines a number of unused keys in the set of public keys satisfies a key generation criterion; and
causes a new set of public keys to be generated, the new set of public keys comprising the unused keys, the active key, and a new public key.

10. The system of claim 1, wherein the second cryptographic operation comprises utilizing the second public key to encrypt the second data, and to cause the encrypted second data to be provided to the second application, ledger further:
provides the encrypted second data to the first application; or
provides the encrypted second data to the second application on behalf of the first application.

11. A method comprising:
storing, in a ledger database, a set of public keys associated with a first user account;
assigning a first public key of the set of public keys as an active key;
responsive to receiving an update key request from a first computing device on behalf of the first user account, updating the active key to a second public key of the set of public keys; and
responsive to receiving an active key request from a second computing device on behalf of a second user account, causing a cryptographic operation to be performed using the second public key.

12. The method of claim 11, wherein said causing the cryptographic operation to be performed comprises:
causing data accessible to the second computing device to be encrypted using the second public key.

13. The method of claim 12, wherein said causing the data to be encrypted comprises:
providing the second computing device access to the second public key; or
utilizing the second public key to encrypt the data and causing the encrypted data to be provided to the first computing device.

14. The method of claim 11, further comprising:
generating the set of public keys based on a seed value;
receiving an undetermined public key; and
determining whether the undetermined public key is part of the set of public keys based on the seed value and the undetermined public key.

15. The method of claim 11, wherein the first public key is associated with a first count value in a sequence of count values, the second public key is associated with a second count value in the sequence of count values subsequent to the first count value, an active count is set to the first count value, and said updating the active key comprises:
incrementing the active count to the second count value.

16. The method of claim 11, further comprising:
determining a number of unused keys in the set of public keys satisfies a key generation criterion; and
causing a new set of public keys to be generated, the new set of public keys comprising the unused keys, the active key, and a new public key.

17. A computer readable storage medium comprising programming instructions encoded thereon, the programming instructions structured to cause a processor to perform a method, the method comprising:
storing, in a ledger database, a set of public keys associated with a first user account;
assigning a first public key of the set of public keys as an active key;
responsive to receiving an update key request from a first computing device on behalf of the first user account, updating the active key to a second public key of the set of public keys; and
causing a cryptographic operation to be performed using the second public key.

18. The computer readable storage medium of claim 17, wherein said causing a cryptographic operation to be performed using the second public key comprises:
providing a second computing device access to the second public key;
utilizing the second public key to authenticate a signature;
utilizing the second public key to verify integrity of first data; or
utilizing the second public key to encrypt second data accessible to the second computing device and causing the encrypted data to be provided to the first computing device.

19. The computer readable storage medium of claim 17, wherein the first public key is associated with a first count value in a sequence of count values, the second public key is associated with a second count value in the sequence of count values subsequent to the first count value, an active count is set to the first count value, and said updating the active key comprises:
incrementing the active count to the second count value.

20. The computer readable storage medium of claim 11, the method further comprising:
providing a second computing device associated with a second user account and a third computing device associated with a third user account access to the second public key.
